(19) United States
(12) Patent Application Publication
(10) Pub. No.: US 2024/0356368 A1
(43) Pub. Date: Oct. 24, 2024

(54) RENEWABLE ENERGY METERING AND MONITORING DEVICE, SYSTEM AND METHOD OF TAMPER-RESILIENT RENEWABLE ENERGY PRODUCTION VERIFICATION

(71) Applicant: CARBON PESA LIMITED, HARROW WEALD (GB)

(72) Inventors: ELVIN MUTUMA MARANGU, HARROW WEALD (GB); AMEET LALCHAND SHAH, HARROW WEALD (GB)

(73) Assignee: CARBON PESA LIMITED, HARROW WEALD, KH (GB)

(21) Appl. No.: 18/640,696

(22) Filed: Apr. 19, 2024

Related U.S. Application Data
(60) Provisional application No. 63/497,975, filed on Apr. 24, 2023.

(51) Int. Cl. H02J 13/00

(52) U.S. Cl. CPC H02J 13/00002; H02J 13/00022

(57) ABSTRACT

A renewable energy metering and monitoring device includes a network interface that establishes a communication channel with one or more inverters at a renewable energy production source site. A data acquisition circuit acquires raw renewable energy production data based on data signals directly obtained from one or more inverters over the established communication channel. A meter monitors and record an amount of renewable energy generated as well as a date and a duration when the renewable energy is generated. A sensor circuit board communicatively coupled to one or more sensors generates sensor information indicative of on-the-ground ambient conditions that exist during renewable energy production at the renewable energy production source site and a controller communicates a plurality of renewable energy production datasets to a central cloud server to generate an electronically verifiable span data package from the plurality of renewable energy production datasets.

### CROSS-REFERENCE TO RELATED APPLICATIONS/INCORPORATION BY REFERENCE

This application makes reference to, claims benefit from, and claims priority to U.S. Provisional Application Ser. No. 63/497,975, which was filed on Apr. 24, 2023.

The above referenced application is hereby incorporated herein by reference in its entirety.

### FIELD OF TECHNOLOGY

The present disclosure relates generally to the field of renewable energy management systems and, more specifically, to a renewable energy metering and monitoring device, a system and a method of tamper-resilient capture and verification of renewable energy production.

### BACKGROUND

In recent years, there has been a concerted global effort to transition towards renewable energy sources as a pivotal strategy to combat climate change and reduce dependence on fossil fuels. The transition towards renewable energy sources has spurred the creation of various renewable energy certification systems aimed at monitoring and validating the generation and consumption of renewable energy. Typically, the generation of renewable energy certificates (RECs) is governed by analog, trust-based systems, where energy producers self-report their renewable energy production either manually or using a paper-based approach. The reliance on self-reporting includes a lot of human touch points, which may lead to potential inaccuracies. Moreover, the conventional methods and systems associated with the issuance of RECs have typically involved manual or paper-based procedures, encompassing project registration, physical metering, and manual verification processes conducted by designated authorities.

Involving third-party verification of RECs and the development of international standards has addressed some of the challenges faced in relation to certification. However, the third-party verification of RECs and adoption of international standards is partially implemented, leading to fragmentation and inconsistency in the renewable energy market. For example, reliably capturing and tracking renewable energy production data at renewable energy installation sites without any potential for inaccuracies remains a technical challenge.

Further limitations and disadvantages of conventional and traditional approaches will become apparent to one of skill in the art through comparison of such systems with some aspects of the present disclosure as set forth in the remainder of the present application with reference to the drawings.

### BRIEF SUMMARY OF THE DISCLOSURE

A renewable energy metering and monitoring device, system and method of tamper-resilient capture and verification of renewable energy production, substantially as shown in and/or described in connection with at least one of the figures, as set forth more completely in the claims. The disclosed renewable energy metering and monitoring device, system, and method ensure transparency and accountability in renewable energy production. The disclosed renewable energy metering and monitoring device, system and method provide a technology-based solution that provides transparency and assurance to end-to-end workflow involved in the production, tracking, and verification of the renewable energy production at renewable energy installations and further issuance of an improved form of Renewable Energy Certificates (RECs), called as DIGIRECs for electricity, which is compatible to the relevant REC issuing entity standard. Embodiments of the present disclosure substantially eliminate or at least partially address the aforementioned problems in the prior art, and improve the tracking, validation and verification of renewable energy production and further improve the transparency in processes related to the issuance of Digital Renewable Energy Certificates (DIGIRECs) for electricity.

These and other advantages, aspects, and novel features of the present disclosure, as well as details of an illustrated embodiment thereof, will be more fully understood from the following description and drawings.

### BRIEF DESCRIPTION OF DRAWINGS

Embodiments of the present disclosure will now be described, by way of example only, with reference to the following diagrams wherein:

FIG. 1 is a diagram illustrating various exemplary components of a system of tamper-resilient capture and verification of renewable energy production, in accordance with an embodiment of the present disclosure;

FIG. 2 is a diagram illustrating various exemplary components of a central cloud server, in accordance with an embodiment of the present disclosure;

FIG. 3A is a diagram illustrating various exemplary components of a renewable energy metering and monitoring device, in accordance with an embodiment of the present disclosure;

FIG. 3B is a diagram illustrating various exemplary components of a renewable energy metering and monitoring device, in accordance with another embodiment of the present disclosure;

FIG. 3C is a diagram illustrating various on-the-ground ambient conditions that exist during renewable energy production at a renewable energy production source site, in accordance with an embodiment of the present disclosure;

FIG. 4 is a diagram illustrating an electronically verifiable span data package, in accordance with an embodiment of the present disclosure;

FIG. 5 is a diagram illustrating various features of an interactive DIGIREC asset, in accordance with an embodiment of the present disclosure;

FIG. 6 is a diagram illustrating a flowchart of a method of tamper-resilient capture and verification of renewable energy production, in accordance with an embodiment of the present disclosure; and

FIGS. 7A and 7B collectively, is a diagram illustrating a flowchart of a method of tamper-resilient capture and verification of renewable energy production, in accordance with another embodiment of the present disclosure.

### DETAILED DESCRIPTION OF THE DISCLOSURE

Certain embodiments of the disclosure may be found in a renewable energy metering and monitoring device, system and method of tamper-resilient capture and verification of renewable energy production.

In conventional systems and methods, typically, the entity that generates the renewable energy typically self-reports on the energy production or carbon reduction activity. Self-reporting may be prone to errors. Currently, it is technically challenging to accurately validate the renewable energy production information at the source of production site to a granular level in a reliable manner.

In contrast to the conventional systems, the disclosed renewable energy metering and monitoring device, system, and method covers the entire lifecycle of renewable energy production data in a holistic approach, from accurate and tamper-resilient recording of the renewable energy data produced at a renewable energy production source site to monitoring and verifying the reported values of the actual renewable energy produced at the renewable energy production source site. A special-purpose device may be installed at the renewable energy production source site referred to as the renewable energy metering and monitoring device for the tamper-resilient recording of the renewable energy data produced at the renewable energy production source site. An amount of renewable energy produced by a list of renewable energy generation devices at the renewable energy production source site when converted to alternating current (AC) for electricity via inverters is read directly by the renewable energy metering and monitoring device in a secured device-to-device communication between the renewable energy metering and monitoring device and the inverters. The renewable energy production datasets of the renewable energy production source site are acquired not from a user due to self-reporting but are acquired directly from the renewable energy metering and monitoring device located at the renewable energy production source site. From this initial acquisition to all electronic processing operations, including monitoring, verification, and final issuing of interactive DIGIREC assets is immutable. The immutable refers to a property or nature of the system that ensures that the recorded and processed data cannot be tampered with or altered, providing transparency and integrity in the verification process of the renewable energy production at renewable energy installations. Thus, the immutable electronic processing of renewable energy production data for issuing DIGIRECs for electricity not only prevents any vulnerability of the certification process, but also improves the accuracy and efficiency of the tracking, validation, and verification of the renewable energy production at the renewable energy installations. The disclosed renewable energy metering and monitoring device, system and method eliminate the chances of human error in data reporting or data manipulation related to the renewable energy production at the renewable energy installations. Furthermore, the disclosed renewable energy metering and monitoring device, system and method enable accurate validation and verification of the renewable energy production information at the source of production site to a granular level in a reliable manner, for example, by providing authenticated and tamper-resilient renewable energy production data. The use of authenticated and tamper-resilient renewable energy production data may contribute to levelling the playing field in the renewable energy sector for new entrants or geographically distanced renewable energy suppliers, for example, Global South, by reducing information asymmetry between established players and new entrants. By leveraging electronic processing and verification, the disclosed renewable energy metering and monitoring device, system, and method ensure the reliability and scalability of renewable energy certificates, contributing to more effective carbon reduction efforts and positive climate change impacts.

In the following description, reference is made to the accompanying drawings, which form a part hereof, and in which are shown, by way of illustration, various embodiments of the present disclosure.

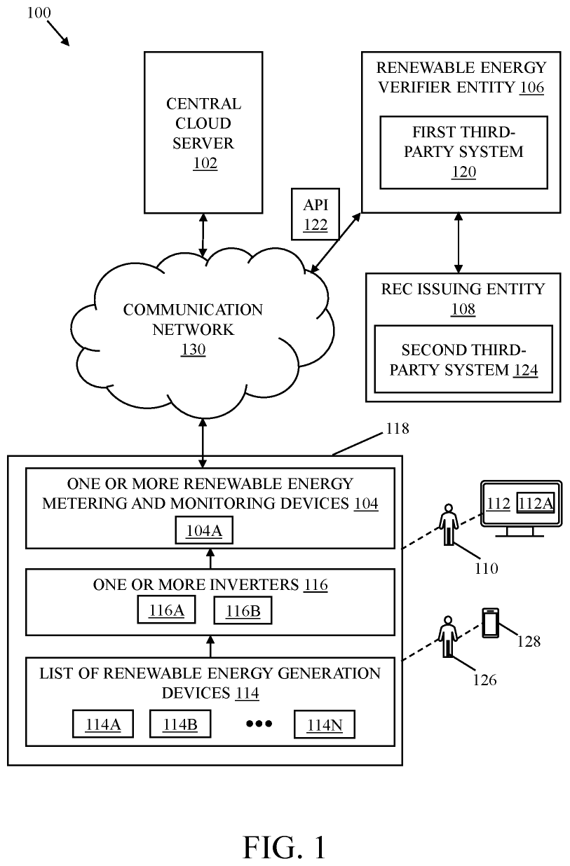

FIG. 1 is a diagram illustrating various exemplary components of a system of tamper-resilient capture and verification of renewable energy production, in accordance with an embodiment of the present disclosure. With reference to FIG. 1, there is shown a system 100 of tamper-resilient capture and verification of renewable energy production. The system 100 may include a central cloud server 102 and one or more renewable energy metering and monitoring devices 104. There is further shown a renewable energy certificate (REC) issuing entity 108. A renewable energy production source site 118 may include a list of renewable energy generation devices 114, one or more inverters 116 and the one or more renewable energy metering and monitoring devices 104. There is further shown a user 110 associated with the renewable energy production source site 118. The user 110 may be an operator who may operate a user device 112 to register various devices at the renewable energy production source site 118, via a front-end interface 112A rendered at the user device 112.

The renewable energy verifier entity 106 may include a first third-party system 120. The central cloud server 102 may communicate with the first third-party system 120 via an application programming interface (API) 122. There is further shown a registered entity 126 (e.g., an owner of the renewable energy production source site 118) who may own or operate another user device 128. In the system 100, a communication network 130 may facilitate communication of data between each of the central cloud server 102, the renewable energy production source site 118, and the renewable energy verifier entity 106.

In the FIG. 1, the list of renewable energy generation devices 114 may include ‘N’ number of renewable energy generation devices, for example, a first renewable energy generation device 114A, a second renewable energy generation device 114B, up to a Nth renewable energy generation device 114N, where N is a positive definite number. The one or more inverters 116 may include for example, a first inverter 116A and a second inverter 116B. The one or more renewable energy metering and monitoring devices 104 may include, for example, a renewable energy metering and monitoring device 104A. In FIG. 1, merely one renewable energy metering and monitoring device (i.e., the renewable energy metering and monitoring device 104A) is shown, for sake of brevity. However, it is to be understood by one of skilled in the art that each the renewable energy production source site 118 may include more than one renewable energy metering and monitoring device depending on need, such as depending on the number of inverters that may require to be connected to the renewable energy metering and monitoring device 104A.

In the FIG. 1, there is provided the system 100 of tamper-resilient capture and verification of renewable energy production that comprises the renewable energy metering and monitoring device 104A disposed at the renewable energy production source site 118 and the central cloud server 102 communicatively coupled to the renewable energy metering and monitoring device 104A. The system 100 may also be referred to as a system of immutable electronic processing of renewable energy production data for issuing DIGIRECs for electricity. The immutable electronic processing may refer to electronic processing of the renewable energy production data in such a way that any alteration or modification is prevented staring from initial recording of the renewable energy production data, intermediate processing, up to issuance of DIGIRECs and even post handling of DIGIRECs after issuance. The immutable electronic processing ensures the integrity, tamper-resilient capture and reliability of the renewable energy production data. The immutable electronic processing may be achieved through device-to-device communication between the one or more renewable energy metering and monitoring devices 104 and the one or more inverters 116 for initial capture and acquisition of raw renewable energy production data, and further use of cryptographic techniques, ensuring that the renewable energy production data remains unchanged and verifiable over time. The system 100 provides a transparent and an electronically verifiable trusted resource for accountability of issued DIGIRECs (an improved form of renewable energy certificates). Moreover, the system 100 eliminates the reliance on self-reported data and provides continuous independent verification and reduces the probability of any data manipulation through the end-to-end workflow or process. Advantageously, the system 100 enables the verification of the renewable energy production data at an atomic level (i.e., at granular level) by providing each and every minute detail of the renewable energy production data. The system 100 also enables the integration of renewable energy certificates into markets, including those in Global South countries with less established electrical grids, and facilitates accurate carbon emission monitoring. Overall, the system 100 addresses the limitations of existing analog or manual systems and enhances the trustworthiness and reliability of renewable energy certificates using a technically advanced system, such as the system 100.

The central cloud server 102 may include suitable logic, circuitry, interfaces and/or code that is configured to periodically acquire a list of renewable energy production datasets from the renewable energy metering and monitoring device 104A located at the renewable energy production source site 118. In an implementation, the central cloud server 102 may be a master cloud server that may be a part of a data center which controls an array of other cloud servers communicatively coupled to the data center for load balancing, running customized applications, and efficient data management. Examples of the central cloud server 102 may include, but are not limited to, an application server, a cloud server, a file server, a web server, a storage server, a virtualization server, or a combination of aforementioned servers.

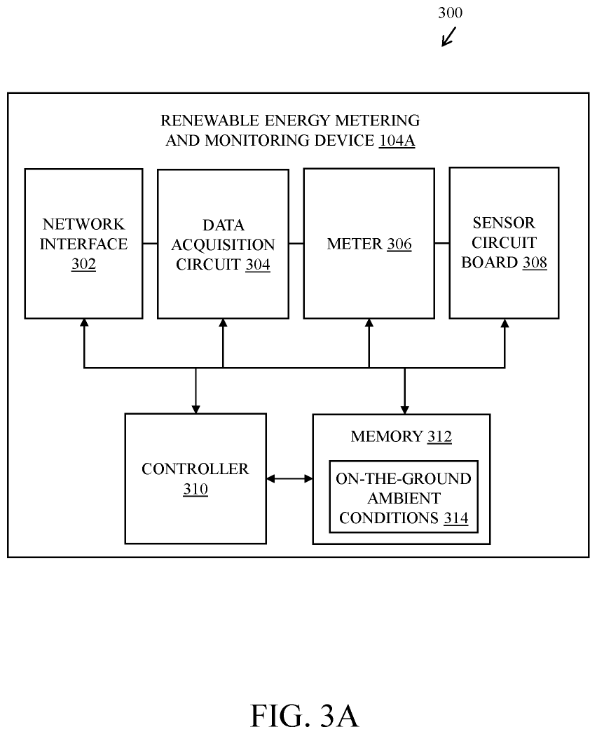

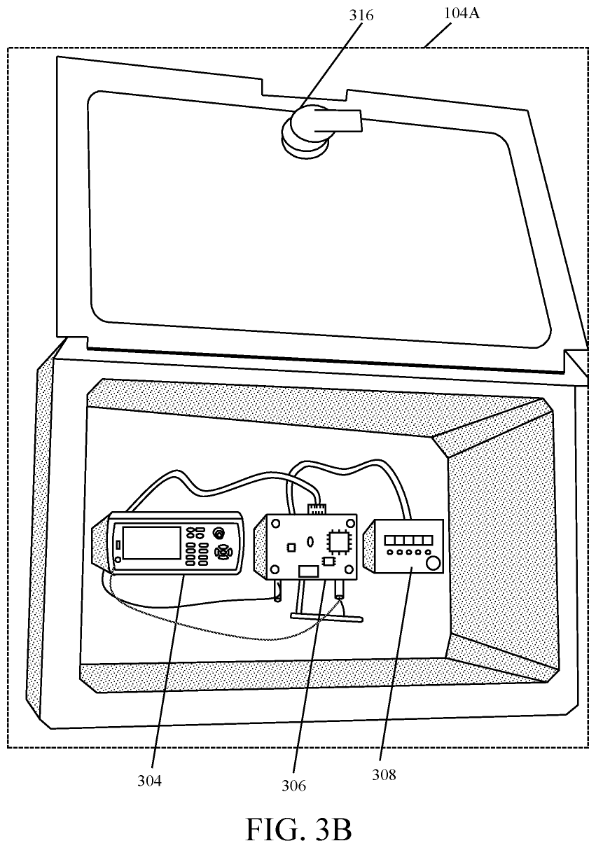

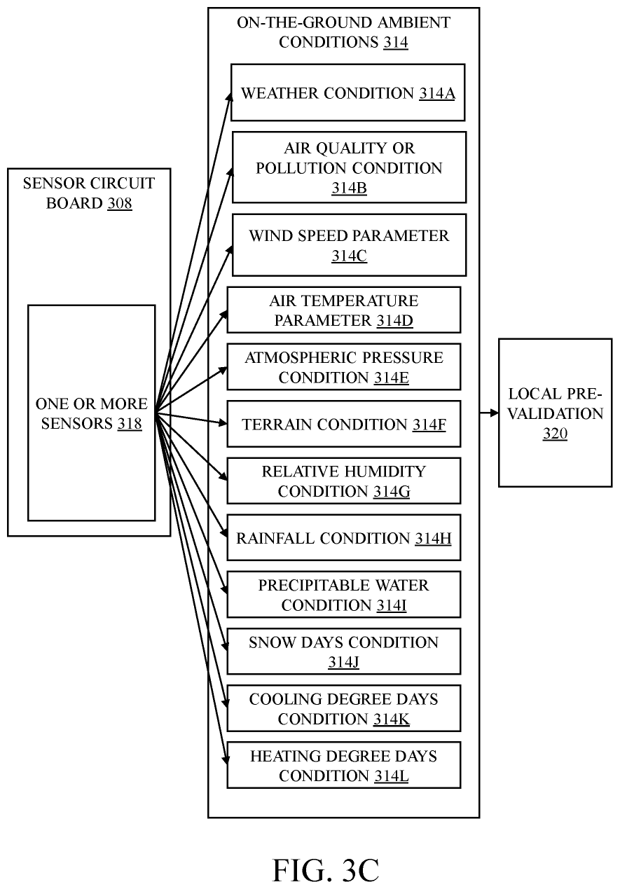

Each of the one or more renewable energy metering and monitoring devices 104 may include suitable logic, circuitry, interfaces and/or code that is configured to establish a communication channel with the one or more inverters 116 at the renewable energy production source site 118. Each of the one or more renewable energy metering and monitoring devices 104, such as the renewable energy metering and monitoring device 104A may be configured to acquire, monitor and track the renewable energy. In an implementation, the renewable energy metering and monitoring device 104A may be installed inside a secure case (at the renewable energy production source site 118) that is locked to prevent any unauthorized access to any individual either working at the renewable energy production source site 118 or prevent any unauthorized remote access other than the central cloud server 102. Examples of implementation of the one or more renewable energy metering and monitoring devices 104 may include, but are not limited to, a special purpose Internet-of-Things (IoT) device, an IoT controller, and the like. The renewable energy metering and monitoring device 104A may have an electrical meter (or a smart meter) and a data acquisition circuit that is in line with the AC electricity produced and transmitted by the one or more inverters 116. The renewable energy metering and monitoring device 104A is described in more detail, for example, in FIGS. 3A and 3B.

The renewable energy verifier entity 106 may include suitable logic, circuitry, interfaces and/or code that is configured to receive a renewable energy certificate (REC) claim request from the central cloud server 102 and perform verification of REC claim request. The renewable energy verifier entity 106 may include the first third-party system 120, which may interact and communicate with the central cloud server 102 via the API 122. Furthermore, the renewable energy verifier entity 106 may separately (without any intervention from the central cloud server 102) may interact with the REC issuing entity 108 (e.g., the issuer) In an example, the renewable energy verifier entity 106 may be the entity responsible for verification and facilitating issuance of RECs (e.g., in coordination with the REC issuing entity 108) without limiting the scope of the disclosure.

The REC issuing entity 108 may include suitable logic, circuitry, interfaces and/or code that is configured to issue the first REC, which is facilitated and coordinated by the renewable energy verifier entity 106. The REC issuing entity 108 may include the second third-party system 12. In practice, the central cloud server 102 may not directly interact with the REC issuing entity 108 or its sub-systems, such as the second third-party system 124. The renewable energy verifier entity 106 may interact with the REC issuing entity 108 and facilitate the acquisition of a unique identifier of a REC. The REC issuing entity 108 may be different for different jurisdictions or countries.

The user 110 may be an operator responsible for managing or operating the renewable energy production source site 118. Examples of the user device 112 may be a laptop, a desktop, a smart phone, and the like. The front-end interface 112A may be rendered at the user device 112. In an example, the front-end interface 112A may correspond to a web-based dashboard accessible through a browser on the user device 112, where the dashboard may display information, such as energy production levels, present status of each of the list of renewable energy generation devices 114, and historical data related to the energy production levels in a user-friendly format.

Each of the list of renewable energy generation devices 114 may be configured to harness naturally occurring and replenishable energy sources to produce electricity or other forms of energy without depleting finite resources and causing significant harm to the environment. Examples of the list of renewable energy generation devices 114 installed at the renewable energy production source site 118 may include, but are not limited to, solar panels, wind turbines, tidal turbines, hydroelectric dams, biomass power plants, geothermal power plants, solar water heaters, wave energy converters, and the like.

Each of the one or more inverters 116 may be a power electronic device installed at the renewable energy production source site 118 that is configured to convert direct current (DC) generated by each of the list of renewable energy generation devices 114 into alternating current (AC) electricity suitable for use, for example, either supplied to an electric grid or to fulfil the captive needs of an individual accessing the renewable energy production source site 118. Each of the one or more inverters 116 may have a data port that is configured to transmit signals comprising the data in digital form and are structured to communicate data including the amount of renewable energy generated by the list of renewable energy generation devices 114, the time (e.g., the time or time duration when the energy is generated), and identification information of the list of renewable energy generation devices 114 and the one or more inverters 116. The one or more inverters 116 may include a self-protection circuitry for self-protection of its electrical circuitry to avoid excess generation of electricity, which avoids any tampering with its DC to AC conversion circuit, thereby maintaining integrity in renewable energy production data.

The renewable energy production source site 118 may correspond to an industrial facility dedicated to generating renewable energy, such as a solar farm, hydropower, large wind turbine facility, and the like, for either captive power consumption or supply the generated renewable energy to a grid (as part of the sale of energy to the grid) for commercial purpose. Other types or scales of the renewable energy generation facilities may also be included.

The registered entity 126 may be an individual or an entity (e.g., an organization) who has an ownership of the renewable energy production source site 118. The registered entity 126 may be configured to access information related to the DIGIREC through the user device 128. Examples of the user device 128 may include, but are not limited to, a laptop, a desktop, a smart phone, a tablet, and the like. Through the user device 128, the registered entity 126 may be configured to monitor the overall process of issuing the DIGIREC.

The communication network 130 may include a medium (e.g., a wired or wireless channel) through which each of the central cloud server 102, and the one or more renewable energy metering and monitoring devices 104), and the renewable energy verifier entity 106 potentially communicates with each other. Examples of the communication network 130 may include, but are not limited to, the Internet, a cellular network, a Local Area Network (LAN), a wide area network (WAN), a Metropolitan Area Network (MAN), and/or the Internet.

In accordance with an embodiment, the central cloud server 102 is configured to obtain a registration request for the list of renewable energy generation devices 114 and the one or more inverters 116 at the renewable energy production source site 118 from the user device 112 via the front-end interface 112A rendered at the user device 112 and communicatively coupled to the central cloud server 102. The front-end interface 112A rendered at the user device 112 may either be a web-based portal, or an application installed in a user device (e.g. the user device 112), or an interface in communication with at least one of the one or more renewable energy metering and monitoring devices 104. The registration request may include site information related to the renewable energy production source site 118 and device information related to each of the list of renewable energy generation devices 114 and each of the one or more inverters 116. The central cloud server 102 may be configured to process the registration request and extract the site information of the renewable energy production source site 118 and the device information of each of the list of renewable energy generation devices 114 and the one or more inverters 116 received with the registration request.

In an implementation, the central cloud server 102 may trigger a third-party verification to inspect and confirm the site information and the device information for each device at the renewable energy production source site 118 upon receiving the registration request from the user 110 (e.g., the operator). In another implementation, the central cloud server 102 may send a notification or an alert to an authorized personnel associated with the central cloud server 102 to visit the renewable energy production source site 118 and install the one or more renewable energy metering and monitoring devices 104 at the renewable energy production source site 118.

In operation, the central cloud server 102 is configured to periodically acquire a plurality of renewable energy production datasets from the renewable energy metering and monitoring device 104A located at the renewable energy production source site 118. The plurality of renewable energy production datasets may include various metrics and parameters depending on an application scenario. For example, the plurality of renewable energy production datasets may include information about the renewable energy sources being utilized (e.g., solar, wind, hydroelectric, biomass, etc.), a time period over which the renewable energy production is measured (e.g., hourly, daily, monthly, or annually), a geographical location of the renewable energy production source site 118 (e.g., country, region, state, or specific installation site location coordinates), installed capacity of the list of renewable energy generation devices 114 (e.g., kilowatts (KW), megawatts (MW), or gigawatts (GW)), an actual amount of electricity generation capacity by each renewable energy generation device of the list of renewable energy generation devices 114 (usually measured in kilowatts-hours (kWh), megawatt-hours (MWh), or gigawatt-hours (GWh)), information on how renewable energy production is integrated to an electrical grid, including grid stability, balancing, and dispatch, and the like.

In accordance with an embodiment, the renewable energy metering and monitoring device 104A at the renewable energy production source site 118 is communicatively coupled to a corresponding data port of the one or more inverters 116 located at the renewable energy production source site 118. In an implementation, the renewable energy metering and monitoring device 104A of the one or more renewable energy metering and monitoring devices 104 may have one or more data ports for communicative coupling to each of the first inverter 116A and the second inverter 116B of the one or more inverters 116. The renewable energy metering and monitoring device 104A may be configured to receive signals from the one or more inverters 116 through the one or more data ports. The signals may include the renewable energy production data. The renewable energy production data may be in a digital format and may include an amount of renewable energy generated by each of the list of renewable energy generation devices 114, a duration of renewable energy generation, and identification information (IDs) corresponding to each of the one or more inverters 116. By establishing the communicative coupling between the renewable energy metering and monitoring device 104A and the one or more inverters 116, the system 100 enables continuous and independent validation of the renewable energy produced at a given installation site. The secured communication between the renewable energy metering and monitoring device 104A and the one or more inverters 116 can be made using wired or wireless communication, or a combination thereof.

The central cloud server 102 is further configured to assign a timestamp and a hash value to each renewable energy production dataset of the plurality of renewable energy production datasets acquired from the renewable energy metering and monitoring device 104A. The timestamp at each renewable energy production dataset may indicate the exact time and duration for which the renewable energy production is measured. The hash value may ensure that the chronology of the acquired renewable energy production dataset is preserved, aiding in the traceability and auditability of the plurality of renewable energy production datasets. The hash value may be a unique fixed-size string of characters representing an original data associated with the one or more inverters 116. In an implementation, the hash value may act as a digital fingerprint for each renewable energy production dataset, allowing for verification of the integrity of the plurality of renewable energy production datasets. By assigning the timestamp and the hash value to each renewable energy production dataset, the immutability of each renewable energy production dataset is ensured. This means that once the data is recorded, the data cannot be altered or tampered with, providing a reliable and transparent record of renewable energy production. The use of the timestamp and the hash value eliminates the inaccuracies in carbon emission monitoring and facilitates integration with renewable energy certificate markets.

In accordance with an embodiment, the central cloud server 102 is further configured to acquire, from the one or more renewable energy metering and monitoring devices 104 at the renewable energy production source site 118, sensor information indicative of on-the-ground ambient conditions that exist during renewable energy production at the renewable energy production source site 118 influencing production of renewable energy at each renewable energy production source site. The sensor information acquired from the one or more renewable energy metering and monitoring devices 104 may include environmental data, such as temperature, sunlight intensity, wind speed, humidity, air pressure, and other relevant environmental factors in the surroundings of the renewable energy production source site 118. The sensor information is collected either continuously or periodically (e.g., every 5 minutes, every hour, or every 2 hours, or a user-defined time interval) from the one or more renewable energy metering and monitoring devices 104. The on-the-ground ambient conditions may directly influence the efficiency and output of the list of renewable energy generation devices 114. By continuously analyzing the on-the-ground ambient conditions during renewable energy production, the system 100 provides more accurate and reliable data related to renewable energy generation.

In an implementation, the renewable energy metering and monitoring device 104A may be configured to generate sensor information indicative of on-the-ground ambient conditions that exist during production of renewable energy at the renewable energy production source site 118 influencing the production of renewable energy. The renewable energy metering and monitoring device 104A may have a sensor circuit board communicatively coupled to one or more sensors, which may be configured to generate the sensor information indicative of the on-the-ground ambient conditions, as shown and described in detail, for example, in FIGS. 3A, 3B and 3C.

In accordance with an embodiment, an amount of renewable energy produced by the list of renewable energy generation devices 114 at the renewable energy production source site 118 when converted to alternating current (AC) for electricity via the one or more inverters 116 is read directly by the renewable energy metering and monitoring device 104A in a secured device-to-device communication between the renewable energy metering and monitoring device 104A and the one or more inverters 116. The secure device-to-device communication between the renewable energy metering and monitoring device 104A and the one or more inverters 116 ensures the integrity and confidentiality of the renewable energy production data, mitigating the risk of unauthorized access or tampering with the renewable energy production data. In addition, the secure device-to-device communication may facilitate an immediate detection of any discrepancies or anomalies in renewable energy production data, allowing for timely intervention to maintain the renewable energy production at the renewable energy production source site 118.

In an implementation, the renewable energy metering and monitoring device 104A may be configured to acquire raw renewable energy production data as electricity is generated from one or more renewable energy generation devices at the renewable energy production source site 118, based on data signals directly obtained from the one or more inverters 116 over the established communication channel. The raw renewable energy production data may include information such as the amount of renewable energy generated, the time of production, and identification details of the location and the inverters. By directly obtaining the data signals from the one or more inverters 116, the possibility of tampering or manipulating the data is eliminated and the tamper-resilient capturing of the raw renewable energy production data is ensured.

The renewable energy metering and monitoring device 104A is configured to monitor and record an amount of renewable energy generated as well as a date and a duration when the renewable energy is generated. The renewable energy metering and monitoring device 104A comprises an electrical meter (or a smart electrical meter, shown and described, for example, in FIGS. 3A and 3B), which may be configured to monitor and record the amount of renewable energy generated along with the date and duration of the renewable energy generation.

The renewable energy metering and monitoring device 104A is configured to communicate the plurality of renewable energy production datasets and the sensor information to the central cloud server 102. By securely communicating the plurality of renewable energy production datasets and the sensor information to the central cloud server 102, the system 100 ensures the accuracy and trustworthiness of the renewable energy production data. This further enables an effective tracking, validation, and verification of renewable energy production.

In accordance with an embodiment, the central cloud server 102 is further configured to ascertain whether the plurality of renewable energy production datasets indicative of an amount of renewable energy generated over a period of time is congruent with the sensor information indicative of the on-the-ground ambient conditions. By comparing the renewable energy production datasets with the sensor information reflecting the on-the-ground ambient conditions, the central cloud server 102 can ascertain the congruence between the two sets of data, ensuring the accuracy and reliability of the renewable energy production information.

In accordance with an embodiment, the central cloud server 102 is further configured to form a renewable energy tracking database comprising, for each renewable energy production source site: the plurality of renewable energy production datasets indicative of an amount of renewable energy generated, a date and duration when the renewable energy is generated along with supplementary information comprising a location of the renewable energy production source site 118, a fuel type indicative of a type of renewable energy used, an evidence type, and device information of the list of renewable energy generation devices 114 and the one or more inverters 116 registered at the central cloud server 102 for each renewable energy production source site. The formation of the renewable energy tracking database including the amount of renewable energy generated, the duration for which the renewable energy is generated, the location of the renewable energy production source site 118, the fuel type, the evidence type, the device information, and the like, ensures the transparency, reliability and accountability in the system 100. Additionally, the formation of the renewable energy tracking database prevents data manipulation and mitigate human errors. The renewable energy tracking database may further include generation feedstock representing source or raw material used in generation of the renewable energy. The renewable energy tracking database may also include other business data.

In accordance with an embodiment, the device information comprises two or more of: a unique device identifier of each registered device of the list of renewable energy generation devices 114 and the one or more inverters 116, a unique identifier of the renewable energy metering and monitoring device 104A, a Media Access Control (MAC) or Internet protocol (IP) address of one or more renewable energy metering and monitoring devices 104 at the renewable energy production source site 118, a make and a model of each of the list of renewable energy generation devices 114, or a grid connection status of the renewable energy production source site 118. The system 100 tracks and validates renewable energy produced at installations by obtaining the information from various sources. This information includes the unique device identifier for each registered device, such as the list of renewable energy generation devices 114 and the one or more inverters 116. Such information also includes the unique identifier for the renewable energy metering and monitoring device 104A. Additionally, the system 100 collects the MAC or IP address of the one or more renewable energy metering and monitoring devices 104 at the renewable energy production source site 118. Furthermore, the system 100 captures the make and model of each renewable energy generation device as well as records of the grid connection status of the renewable energy production source site 118. By collecting the device information, the system 100 enables the real-time monitoring and reporting of renewable energy generation. Moreover, the collection of the device information eliminates the reliance on self-reported data and provides continuous independent verification of renewable energy production.

In accordance with an embodiment, the renewable energy tracking database further comprises, for each renewable energy production source site, geographical information of the renewable energy production source site 118 including one or more of: satellite-sensed solar irradiation measurements, weather forecast information, site-specific sensed weather condition information, wind speed information, air temperature information, atmospheric pressure information, air quality or pollution information, relative humidity (RH) information, site-specific rainfall information, precipitable water information, snow days information, CoolingDegree Days (CDDs) information; HeatingDegree Days (HDDs) information, terrain information, or data from local weather stations associated with each renewable energy production source site, and where the central cloud server 102 is further configured to predict an amount of energy loss for a given geographical location of the renewable energy production source site for a given time period and co-relate with the plurality of renewable energy production datasets. The system 100 may be configured to obtain the geographical information for each renewable energy production source site, such as the renewable energy production source site 118. The geographical information is collected through various sources, including but not limited to, the satellite-sensed solar irradiation measurements, weather forecast data, air temperature measurements, atmospheric pressure information, air quality or pollution information, relative humidity (RH) information, terrain information, and data from local weather stations associated with each renewable energy production source site. The increased changes in the climate causes frequent fluctuations in weather that make solar irradiations unpredictable, which directly impact the renewable energy generation. In order to reduce the increased changes in the climate, there is a requirement to measure the ground level weather related data, such as air temperature information, atmospheric pressure information, air quality or pollution information, relative humidity (RH) information, site-specific rainfall information, precipitable water information, snow days information, CoolingDegree Days (CDDs) information; HeatingDegree Days (HDDs) information, and the like. Moreover, the tropics despite having the least number of weather stations, has the greatest negative discrepancy between solar irradiance and solar accuracy. The central cloud server 102 may be configured to address the increased changes in the climate and the negative discrepancy between solar irradiance and solar accuracy at tropics by considering the measurement of the ground level weather related data and including the measured data in the renewable energy tracking database. The system 100 also addresses the trust deficit issues that may arise from new, small, unfamiliar, or geographically distanced renewable energy suppliers. The prediction of the amount of energy loss for the given geographical location of the renewable energy production source site 118 for the given time period and co-relation with the plurality of renewable energy production datasets enhances the integrity and accuracy of renewable energy tracking and verification.

In accordance with an embodiment, the central cloud server 102 is further configured to determine an on-the ground performance for each renewable energy generation device of the list of renewable energy generation devices 114 based on the sensor information indicative of the on-the-ground ambient conditions that exist during renewable energy production at the renewable energy production source site 118. The central cloud server 102 may be configured to determine the efficiency and output of the list of renewable energy generation devices 114 by analyzing the sensor information that provides insights into the prevailing on-the-ground ambient conditions during renewable energy production at the renewable energy production source site 118.

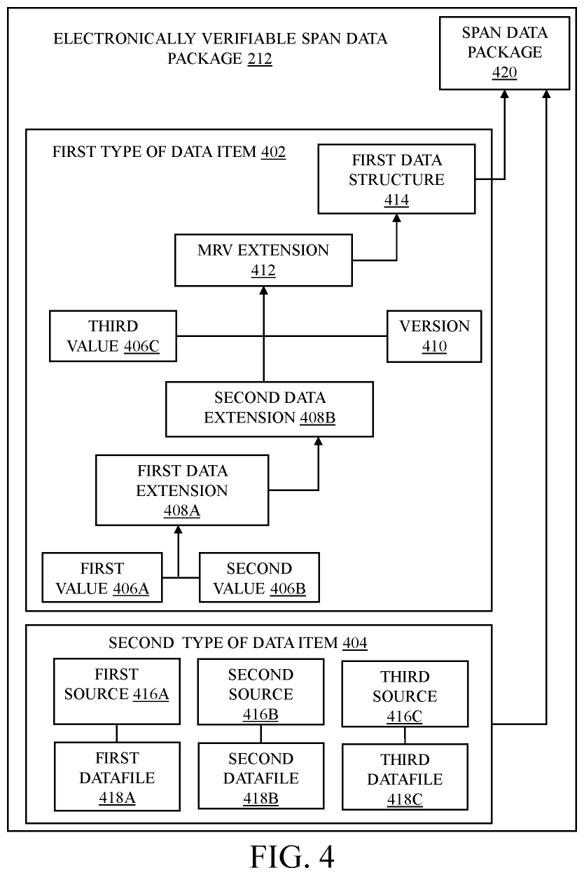

The central cloud server 102 is further configured to generate an electronically verifiable span data package from the plurality of renewable energy production datasets. The central cloud server 102 is further configured to process the electronically verifiable span data package to generate a REC claim request in a defined taxonomy compatible to be read by the API 122 of the first third-party system 120 associated with the renewable energy verifier entity 106. The electronically verifiable span data package may be a corroborating renewable energy production data evidence package stored in the central cloud server 102. The electronically verifiable span data package may correspond to a specific type of data package collected over a time span, which is tamper-resilient and facilitates to provide evidence of how, when, and where the renewable energy production data was generated and by which device. In an example, the electronically verifiable span data package may have a specific custom-designed data structure that may have data associated with the registered sources, such as the list of renewable energy generation devices 114 and the one or more inverters 116 installed at the renewable energy generation source site 104, and other associated evidence information. An example of the electronically verifiable span data package is described in detail, for example, in FIG. 4. The electronically verifiable span data package may be processed to generate the REC claim request. For example, certain information may be extracted from the electronically verifiable span data package to automatically create the REC claim request. For instance, data fields, such as a device code indicative of inverter ID (GIGIES10001-inverter1), a recipient account code (e.g., ETAP92WN) indicative of renewable energy installation site ID or account ID of renewable energy installation, a fuel code (e.g., ES100-Solar) indicative of a type of renewable energy source, a country (e.g., KE-Kenya) indicative of the country of where the renewable energy production occurred, a start date (e.g., 2023 Oct. 9), end date (e.g., 2023 Oct. 11), and period production (e.g., 1.00 MWh) indicative of total renewable energy produced during the start date and the end date. Such data may be extracted from the span data package to generate the REC claim request, for example, claiming the generation of renewable energy of 1 MWh from a solar energy installation located in Kenya over the date range of Oct. 9-11, 2023, in an example. The central cloud server 102 generates the REC claim request in a defined taxonomy suitable to be processed further by the first third-party system 120. The defined taxonomy may serve as a standardized framework for categorizing and organizing the renewable energy production data associated with each of the plurality of renewable energy production dataset. In addition, the defined taxonomy and compatibility of the REC claim request with the API 122 may ensure that the plurality of renewable energy production datasets are seamlessly integrated and accessed by the first third-party system 120, enhancing trust and accountability in the renewable energy market.

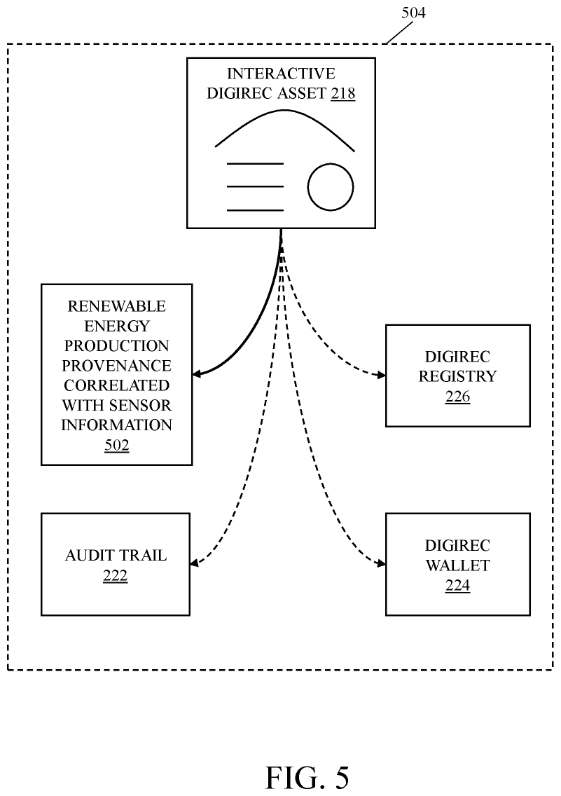

In accordance with an embodiment, the electronically verifiable span data package may include a first type of data item comprising REC claim information details, a claim date of the REC claim request, a checkpoint source, a data structure related to the defined taxonomy, a fuel type indicative of a type of renewable energy used, a production capacity of the renewable energy production source site 118, an identifier of the renewable energy production source site 118, and an account information associated with the renewable energy production source site 118 assigned by the renewable energy verifier entity 106. In an implementation, the electronically verifiable span data package may have data from registered sources, which is stored as evidence for the REC claim request. For instance, the first type of data item may be, for example, a “manifest.json” file, which may comprise detailed information on the REC claim, the REC claim date, generation feedstock, and the taxonomy (i.e., of the relevant REC issuing entity or the relevant REC verifying and issuing entity, for example, taxonomy suited for the first third-party system 120) that has been implemented by the renewable energy metering and monitoring device 104A. Additionally, the first type of data item may have the name (i.e., identifier) of the renewable energy production source site 118, fuel type, production capacity and the respective account as assigned by the renewable energy verifier entity 106. The first type of data item is further shown and described in detail, for example, in FIG. 5. By utilizing at least a portion of the electronically verifiable span data package and the generated REC claim request, the system 100 ensures continuous independent verification of renewable energy production data to a granular or atomic level, reducing the risk of manipulation and inaccuracies while improving transparency of the renewable energy production. In an example, some information from the first data item of the electronically verifiable span data package may be processed to generate the REC claim request.

In accordance with an embodiment, the electronically verifiable span data package may further include a second type of data item comprising a list of device identities (IDs) and corresponding renewable energy production data associated with each device ID over a specified period as source evidence. In an implementation, the second type of data item may correspond to a source evidence file that may have data related to the renewable energy production over a specific period of time. The list of device identities (IDs) may correspond to unique identities of each of the list of renewable energy generation devices 114, and the one or more inverters 116. The second type of data item is further shown and described, for example, in FIG. 5. By including the list of device identities and energy production data, the system 100 provides a trusted resource for accountability of RECs. In an example, some information from the second data item of the electronically verifiable span data package may be further processed to generate the REC claim request, for example, the start date, the end date, and the device ID of inverter, and total energy generated, etc. The second type of data item may comprise evidence of the renewable energy production over a specific period of time (the start date and end date), which may be communicated or uploaded as additional evidence for verification by the first third-party system 120 along with the REC claim request (e.g., via a UI).

In accordance with an embodiment, after the REC claim request is generated, the central cloud server 102 is further configured to perform pre-validation of the REC claim request prior to communicating the REC claim request to the first third-party system 120 for verification. In other words, the central cloud server 102 is further configured to execute a local pre-validation of the plurality of renewable energy production datasets acquired from the renewable energy metering and monitoring device 104A using one or more defined checkpoints prior to verification of the REC claim request by the first third-party system 120 associated with the renewable energy verifier entity 106. The local pre-validation of the plurality of renewable energy production datasets may include checking for anomalies, inconsistencies, or errors, if any, in each of the plurality of renewable energy production datasets. The local pre-validation also includes validating that the renewable energy production data associated with the plurality of renewable energy production datasets meets the pre-defined quality standards and regulatory requirements. The local pre-validation may be done using the one or more defined checkpoints. Each of the one or more defined checkpoints may represent a time-bound (including a start time and an end time) energy production as received from each of the one or more renewable energy metering and monitoring devices 104. In addition, each of the one or more defined checkpoints may include a corresponding hash value that confirms the integrity of the renewable energy production data associated with the plurality of renewable energy production datasets. The central cloud server 102 may be configured to apply the one or more (e.g., ‘N’ number) defined checkpoints to ensure the integrity, accuracy, and compliance of the acquired renewable energy production data associated with the plurality of renewable energy production datasets. In an example, a checkpoint may be applied for a defined duration, for example, 2 hours, during which the renewable energy metering and monitoring device 104A acquires the renewable energy production data from the one or more inverters 116. On execution of the local pre-validation of the plurality of renewable energy production datasets, the central cloud server 102 may be configured to trigger the REC claim request. The local pre-validation of the plurality of renewable energy production datasets may proactively minimize the risk of errors or discrepancies in the REC claims, further enhancing the credibility and transparency of the system 100.

The central cloud server 102 is further configured to trigger and communicate the REC claim request along with a portion of the electronically verifiable span data package as evidence to the first third-party system 120. The portion of the electronically verifiable span data package may be the second data item (e.g., the source evidence file) providing evidence of renewable energy production specific to what is claimed in the REC claim request. The REC claim request may provide the details of the source of the renewable energy, and time period of the renewable energy generation to the first third-party system 120 (i.e., a registry system) that in response, verifies the REC claim request and causes the REC issuing entity 108 to issue a digital certificate, such as an International Renewable Energy Certificate from Electricity (“I-REC(E)”) under the stringent taxonomy regulations adopted for use in the standards for issuing RECs. The REC claim may be an assertion for an amount of renewable energy associated with the electronically verifiable REC claim request and generated at the renewable energy production source site 118. The REC claim request may be generated and triggered by the central cloud server 102 to initiate the issuance of the REC corresponding to the portion of the electronically verifiable span data package that indicates and validates the renewable energy production data acquired from the renewable energy metering and monitoring device 104A. Post generation of the REC claim request, the pre-validation may occur followed by communication of the REC claim request along with the portion of the electronically verifiable span data package as evidence to the first third-party system 120. The first third-party system 120 then verifies the renewable energy production data using the extracted portion of the electronically verifiable span data package.

In accordance with an embodiment, the generation of the REC claim request is triggered when the plurality of renewable energy production datasets periodically acquired from the renewable energy metering and monitoring device 104A indicates that an individual inverter of the one or more inverters 116 has generated a defined amount of renewable energy equal to or greater than a threshold amount or a defined amount of time of renewable energy equal to or greater than a threshold amount. For instance, if either the first inverter 116A or the second inverter 116B of the one or more inverters 116 has generated the defined amount of renewable energy equal to or greater than the threshold amount (e.g., a 1000 kilowatt hours=1 MWh of renewable energy up to, for example, six decimal places, with below megawatt hour resolution to the watt-hour (Wh) optional) or when the duration of renewable energy generation equals or exceeds the defined threshold amount of time then, the central cloud server 102 may be configured to trigger the REC claim request. The central cloud server 102 may be configured to trigger one REC claim request on the generation of one MWh of renewable energy.

In accordance with an embodiment, the generation of the REC claim request is triggered or performed when the plurality of renewable energy production datasets periodically acquired from the renewable energy metering and monitoring device 104A indicates that the one or more inverters 116 collectively at the renewable energy production source site 118 has generated a defined amount of renewable energy equal to or greater than a threshold amount or a defined amount of time of renewable energy equal to or greater than a threshold amount. For instance, if the one or more inverters 116 collectively, has generated the defined amount of renewable energy equal to or greater than the threshold amount (e.g., one Megawatt-hour (MWh)) then, the central cloud server 102 may be configured to trigger the REC claim request. By automating the triggering of the REC claim requests based on specific thresholds, the system 100 ensures a more reliable and accountable resource for RECs.

The central cloud server 102 is further configured to acquire a unique identifier of a first REC issued by the REC issuing entity 108 from the first third-party system 120 when the REC claim request is successfully verified. The unique identifier associated with the first REC ensures the uniqueness of the first REC. The first REC serves as a proof that a certain quantity of electricity (typically 1 one Megawatt-hour (MWh)) is generated using the list of renewable energy generation devices 114 at the renewable energy generation source site 104. Moreover, the issuance of the first REC enables the tracking and verification of renewable energy production for regulatory compliance and voluntary sustainability initiatives. Typically, the first REC may be non-interactive (e.g., a portable document format), having name of the registered entity, such as the registered entity 126, the physical location of the renewable energy generation source site 104, country name, units of electricity generated using the renewable energy, type of renewable energy generated, how much reduction in carbon emission is achieved through the renewable energy generation, and the like. The acquiring of the unique identifier associated with the first REC may ensure that the renewable energy produced at the renewable energy production source site 118 is officially recognized and may be traded or used to meet the renewable energy goals. The acquisition of the unique identifier associated with the first REC from the first third-party system 120 associated with the REC issuing entity 108 enhances the accountability and transparency of the REC issuing process.

The central cloud server 102 is further configured to generate an interactive digital renewable energy certificate (DIGIREC) asset based on predefined REC-taxonomy metadata and the acquired unique identifier, where the interactive DIGIREC asset is associated with an ownership to the registered entity 126 of the renewable energy production source site 118. The interactive DIGIREC asset may be defined as a digital exchangeable energy attribute certificate-based asset that provides an assurance of authenticity and provenance about the production of a unit of electricity through renewable energy through an objective digital evidence chain of custody based on a multi-layered verification of renewable energy production corresponding to the plurality of renewable energy production datasets. This is not possible with the first REC issued by the REC issuing entity 108. The term “interactive” is indicative of the capability bestowed on users, who can click on or interact with the interactive DIGIREC asset to be assured at a granular level (or atomic level) about the authenticity and provenance of renewable energy production claimed in the interactive DIGIREC asset. The interactive DIGIREC asset is different from the first REC, at least in a renewable energy production provenance function associated with the interactive DIGIREC asset. The renewable energy production provenance function allows to authenticate and prove the production of the unit of electricity using renewable sources using the interactive DIGIREC asset. The interactive DIGIREC asset generated based on predefined REC-taxonomy metadata and the acquired unique identifier of the first REC is an absolute, automated, digital, climate-based tradeable financial asset that provides beneficiaries (such as the registered entity 126) real-time transparency to verify the authenticity of each renewable energy certificate issued per megawatt hour (MWh) up to the power generation source of electricity including but not limited to, solar, wind, hydro, geothermal, nuclear, hydrogen, and biofuels. The interactive DIGIREC asset provides the information of the renewable energy production data at an atomic level including numerous metadata points unique to each production plant, but not limited to, geographic location, weather, production time, and other insights provide accurate third-party assurance to fulfil global regulatory requirements, including but not limited to, the US State of California's SB253 Climate Corporate Data Accountability Act and SB261 Greenhouse Gases: Climate-Related Financial Risk requirements. The interactive DIGIREC asset also provides complete transparency to independently verify the authenticity of each certificate down to plant-level GPS coordinates, as well as unbiased verification of the underlying production data that confirms the foundational relevance for the interactive DIGIREC asset based on the relevant REC issuing entity taxonomy. The interactive DIGIREC asset can also be traded via market exchanges to scale its adoption so that organizations can achieve net zero goals based on electricity. Moreover, the interactive DIGIREC asset eliminates the challenges limiting the global markets for primary issuance and secondary trading of over-the-counter (OTC) transactions, including double-counting, pricing transparency, untrusted and unverifiable certificates, and automation trading to support Power Purchase Agreements. The interactive DIGIREC asset may also be referred to as a Digital International Renewable Energy Certificate (DIGIREC) for Electricity.

By transitioning to the digital and self-verifiable capability of the interactive DIGIREC asset, the system 100 enables continuous independent monitoring, verification, and validation of the renewable energy production data and reduces the chances for manipulation of the reported data. Furthermore, the system 100 may establish a clear chain of custody (ownerships by different entities or users) for the interactive DIGIREC asset, enhancing accountability and transparency in renewable energy transactions and ensuring that the value derived from the renewable energy production accrues to the rightful owner. In other words, the system 100 may keep a clear record of who owns the interactive DIGIREC asset at any given time and how they are transferred between various registered entities.

In accordance with an embodiment, the central cloud server 102 is further configured to embed ancillary information in an encrypted form in the interactive DIGIREC asset, and where the ancillary information comprises a production location, production date and timestamp indicative of where and when the interactive DIGIREC asset and related unit of renewable energy is produced. The embedding of the ancillary information in the encrypted form in the interactive DIGIREC asset provides transparent evidence of where and when the interactive DIGIREC asset and its related unit of renewable energy is produced. The encryption of the ancillary information may ensure that any sensitive data related to the interactive DIGIREC asset's production is protected from an unauthorized access or tampering, maintain the integrity, and confidentiality of the information.

In accordance with an embodiment, the central cloud server 102 is further configured to track a redeemed status of the interactive DIGIREC asset based on one or both of: a confirmation from an electronic renewable energy exchange platform that indicates a successful redemption or an expiry of a defined validity period and tagging the interactive DIGIREC asset as no longer available at the central cloud server 102 or the renewable energy exchange platform for further use after receiving the confirmation of the successful redemption or after the expiry of the defined validity period. The central cloud server 102 may be configured to monitor the status of the interactive DIGIREC asset to determine whether the interactive DIGIREC asset is either redeemed or expired. The confirmation from the electronic renewable energy exchange platform (e.g., an online portal of IREC Foundation) may indicate whether the interactive DIGIREC asset has been successfully redeemed or not. The interactive DIGIREC asset has a defined validity period, after which it expires. The central cloud server 102 may be configured to track the expiry of the interactive DIGIREC asset based on the defined validity period. The central cloud server 102 may be configured to maintain an up-to-date record of available certificates, facilitating transparency and trust in the certification process by monitoring the interactive DIGIREC asset for successful redemption or expiry. The interactive DIGIREC asset can be used in a trading exchange to offset, for example, minute-level carbon emissions by the buyer (by redeeming the interactive DIGIREC asset).

In accordance with an embodiment, the tagging of the interactive DIGIREC asset may ensure that redeemed or expired DIGIRECs cannot be reused or issued again, thereby preventing double counting or fraudulent activities. The central cloud server 102 may be configured to receive the identification of the interactive DIGIREC asset and to update the database records to show that the interactive DIGIREC asset is used within the allotted time period (and would block the redemption of expired or previously redeemed certificates (i.e., DIGIREC)). The real-time update of the redeemed certificates (i.e., DIGIREC) prevents unauthorized uses and ensures transparency and reliability in the system 100. The registry can be updated to reflect the redeemed certificate and the associated data.

In accordance with an embodiment, the central cloud server 102 is further configured to generate an audit trail accessible remotely via an audit user interface (UI) to allow a remote or on-site auditing by an authorized auditor to prove one or more renewable energy certificate (REC) claims, and where the audit trail is generated based on the plurality of renewable energy production datasets acquired periodically from the renewable energy metering and monitoring device 104A located at the renewable energy production source site 118. The audit trail is accessible remotely through the audit UI. The authorized auditor can use this interface to conduct either remote or on-site auditing. The audit trail may include a detailed chronological record of activities related to the renewable energy production and the REC claims. The audit trail may include information, such as timestamps, renewable energy production data, REC claim requests, verification outcomes, and any other relevant information related to the interactive DIGIREC asset issuance and verification processes. The authorized auditor may be any authorized individual or entity responsible for verifying the accuracy and validity of the REC claims and may access the audit trail to confirm various aspects of renewable energy production and REC transactions over a period. For example, as the detailed chronological record of activities related to the renewable energy production and the REC claims is stored in the central cloud server 102, beneficially, such renewable energy production activities may be accessed a year or many years later after the DIGIREC has been issued. Thus, there may be a long audit trail to verify the accuracy of the information (e.g., even 10 years later). The authorized auditor may access the audit trail from any place with availability of internet access.

In accordance with an embodiment, the audit trail may be generated further based on local sensor data that influence production of renewable energy at each renewable energy production source site obtained from the one or more renewable energy metering and monitoring devices 104 at the renewable energy production source site 118. The local sensor data may include information about weather conditions, solar irradiance levels, temperature or any other factors affecting renewable energy production. The generation of the audit trail based on local sensor data leads to the improvement in the integrity, accuracy of tracking, validation, and verification of renewable energy production.

In accordance with an embodiment, the central cloud server 102 is further configured to calculate an amount of green and clean electricity achieved from a total amount of renewable energy verifiably produced over a defined period at the renewable energy production source site 118, based on a tracking of the plurality of renewable energy production datasets acquired from the one or more renewable energy metering and monitoring devices 104 and generate a verifiable green and clean electricity report based on the calculated amount of DIGICRECs produced, where the verifiable of green and clean electricity report is accessible for independent third-party verification. The verifiable green and clean electricity report may include detailed information on the calculated amount of DIGICRECs produced, along with relevant data such as the time period covered, methodology used for calculation, and any other pertinent details required for verification. The calculation of the amount of green and clean electricity may assess the impact of environmental factors on renewable energy production and allow stakeholders to quantify the reduction in greenhouse gas emissions attributable to renewable energy generation. Furthermore, the central cloud server 102 may provide access to the verifiable green and clean electricity report for independent third-party verification which may enhance credibility and trust in the reported green and clean electricity generation outcomes. The third-party verification may add an extra layer of assurance regarding the accuracy and reliability of the reported data. Also, access to the green and clean electricity report for independent verification may foster transparency and accountability, supporting trust-building efforts among stakeholders, including investors, regulators, and the public. Moreover, the system 100 contributes to the formation and scaling of carbon offsets and credits, promoting more accurate and reliable carbon emission monitoring and reducing negative climate change impacts.

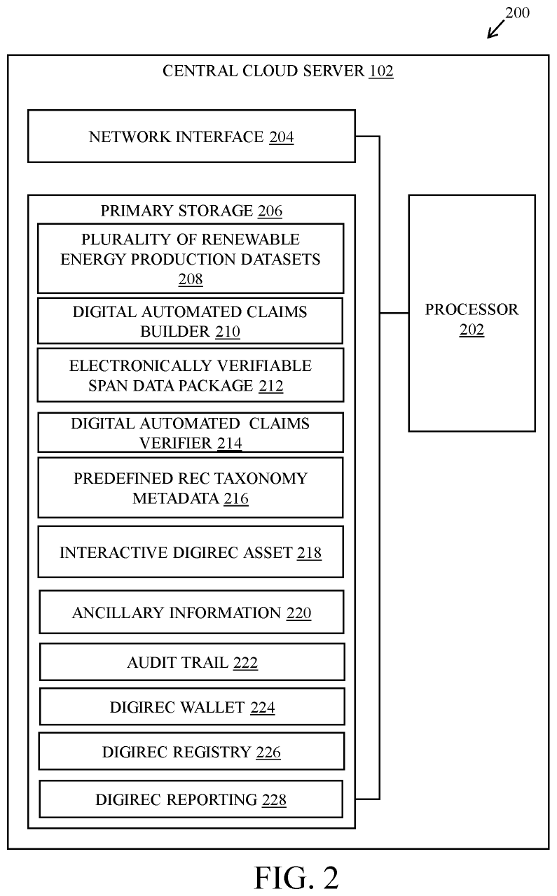

FIG. 2 is a diagram illustrating various exemplary components of a central cloud server, in accordance with an embodiment of the present disclosure. FIG. 2 is described in conjunction with the elements of FIG. 1. With reference to FIG. 2, there is shown a block diagram 200 of the central cloud server 102 that may include a processor 202, a network interface 204 and a primary storage 206. The primary storage 206 may store a plurality of renewable energy production datasets 208, a digital automated claims builder 210, an electronically verifiable span data package 212, a digital automated claims verifier 214, a predefined REC taxonomy metadata 216, an interactive DIGIREC asset 218, ancillary information 220, an audit trail 222, a DIGIREC wallet 224, a DIGIREC registry 226 and a DIGIREC reporting 228. Each of the processor 202, the network interface 204 and the primary storage 206 is communicatively coupled to each other.

The processor 202 may include suitable logic, circuitry, interfaces and/or code that may be configured to execute instructions stored in the primary storage 206. Examples of the processor 202 may include, but are not limited to, an integrated circuit, a co-processor, a microprocessor, a microcontroller, a complex instruction set computing (CISC) processor, an application-specific integrated circuit (ASIC) processor, a reduced instruction set (RISC) processor, a very long instruction word (VLIW) processor, a central processing unit (CPU), a state machine, a data processing unit, and other processors or circuits. Moreover, the processor 202 may refer to one or more individual processors, processing devices, a processing unit that is part of a machine. The processor 202 of the central cloud server 102 may be configured to execute each and every function, which is executed by the central cloud server 102 for issuance of the interactive DIGIREC asset 218.

The network interface 204 may include suitable logic, circuitry, and/or interfaces that is configured to receive the plurality of renewable energy production datasets 208 from the renewable energy metering and monitoring device 104A (of FIG. 1). The network interface 204 enables the central cloud server 102 to communicate with the various entities of the system 100 including the renewable energy production source site 118, and the REC issuing entity 108 through the communication network 130.

The primary storage 206 may include suitable logic, circuitry, interfaces and/or code that is configured to store machine code and/or instructions executable by the processor 202. The primary storage 206 may be configured to store amount or unit of electricity (may be a fractional unit) generated by the renewable energy production source site 118 using the list of the renewable energy generation devices 114 and the one or more inverters 116 and related information including time and location where the renewable energy is generated. The stored information may be used for verification based on time and date at a granular level, such as minutes or seconds, in association with the amount of energy generated. Examples of implementation of the primary storage 206 may include, but are not limited to, an Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer readable storage medium, and/or CPU cache memory. Moreover, the information stored in the primary storage 206 can be backed up to a secondary storage (not shown here for sake of brevity) periodically for fail-safe retrieval of data to mitigate any unforeseen events, such as a hardware or software crash of the renewable energy metering and monitoring device 104A.

The plurality of renewable energy production datasets 208 and the electronically verifiable span data package 212 have been described in detail, for example, in FIG. 1.

The digital automated claims builder 210 may also be referred to as a digital claims builder. In an implementation, the digital automated claims builder 210 may be a part of or may also be referred to as a project application, which may be installed at the central cloud server 102. The digital automated claims builder 210 may be configured to receive the renewable energy production data from the renewable energy metering and monitoring device 104A and convert the data into a tamper-resilient form by the digital automated claims verifier 214, which may be used as evidence for issuing the interactive DIGIREC asset 218. Examples of the digital automated claims builder 210 must be realized on a tamper-resilient platform, which may be implemented using different available technologies. Such technology options may include, but are not limited to, traditional (i.e. non-distributed ledger technology) enterprise data infrastructure or distributed ledger technology (DLT) systems that may include, but are not limited to, renewable energy management software, renewable energy platforms, cloud-based energy analytics platforms, and the like.

Additionally, the digital automated claims builder 210 (e.g., the project application) may be configured to continuously read sensor information indicative of on-the-ground ambient conditions that exist during renewable energy production at the renewable energy production source site 118 influencing production of renewable energy at each renewable energy production source site from the renewable energy metering and monitoring device 104A.

The electronically verifiable span data package 212 corresponds to a tamper-resilient data package and may be used to generate the evidence for triggering a REC claim request. Alternatively stated, the digital automated claims builder 210 may be configured to perform continuous evidence collection and packaging (i.e., continuously reading the renewable energy production data from the renewable energy metering and monitoring device 104A and generating the electronically verifiable span data package 212 (i.e., a portion of which is used as evidence)). The electronically verifiable span data package 212 may include one or more checkpoints where, one checkpoint may represent the renewable energy production in a span of time, including a start time and end time and date of energy production as well. The checkpoint also includes a corresponding hash value assigned to each renewable energy production dataset that confirms the integrity of the renewable energy production dataset.

The digital automated claims verifier 214 is part of the central cloud server 102. The digital automated claims verifier 214 may be configured to process the electronically verifiable span data package 212 and validate the one or more checkpoints. The digital automated claims verifier 214 may be configured to compute the estimated MWh of electricity contained in the one or more checkpoints.

The predefined REC-taxonomy metadata 216 may refer to standardized requirements, which are predefined and designed to facilitate the organization, retrieval and analysis of information related to the interactive DIGIREC asset 218.

The interactive DIGIREC asset 218 may be referred to as a transferrable proof for the generation of one MWh of electricity from renewable energy sources. The interactive DIGIREC asset 218 permits its buyer to claim consumption of one MWh of renewable energy. The interactive DIGIREC asset 218 is generated based on the predefined REC-taxonomy metadata 216 to confirm the buyer's ability to reach Net Zero on Electricity (NZoE) targets.

The ancillary information 220 comprises a production location, a production date and a timestamp indicative of where and when the interactive DIGIREC asset 218 and related unit of renewable energy is produced. The ancillary information 220 may be referred to as supplementary or additional information, data or context that supports the automated issuance process of the interactive DIGIREC asset 218. The ancillary information 220 may include supporting documents, footnotes, metadata, or any other relevant details that enhance understanding or provide additional context related to the interactive DIGIREC asset 218.

The audit trail 222 may be accessible remotely via an audit user interface (UI) to allow remote or on-site auditing by an authorized auditor to prove one or more renewable energy certificate (REC) claims. The audit trail 222 is generated based on the plurality of renewable energy production datasets 208 acquired periodically from the renewable energy metering and monitoring device 104A located at the renewable energy production source site 118. The DIGIREC wallet 224 may be referred to as a software-based system that may be configured to securely store the trading information (including payment methods, websites, passwords, and the like) of the interactive DIGIREC asset 218. By use of the DIGIREC wallet 224, the buyers of the interactive DIGIREC asset 218 can make electronic commercial transactions quickly and securely.

The DIGIREC registry 226 may be referred to as a record-keeping system that may be configured to store all the information related to the interactive DIGIREC asset 218, such as when and where the interactive DIGIREC asset 218 is generated and traded between various registered entities and for what time duration. The DIGIREC registry 226 may provide centralized, searchable and secure storage of information related to the interactive DIGIREC asset 218 and enhance data accessibility of the interactive DIGIREC asset 218.

The DIGIREC reporting 228 may be referred to as the process of creating, distributing and consuming reports related to the interactive DIGIREC asset 218 in a digital format. The DIGIREC reporting 228 may replace traditional paper-based reporting methods with electronic formats and may improve efficiency, accessibility and interactivity. The DIGIREC reporting 228 may encompass various types of reports, such as renewable energy production data, trading reports of the interactive DIGIREC asset 218, and the like.

The processor 202 of the central cloud server 102 may be configured to periodically acquire the plurality of renewable energy production datasets 208 from the renewable energy metering and monitoring device 104A. In addition, the processor 202 of the central cloud server 102 may be configured to assign the timestamp and the hash value to each renewable energy production dataset of the plurality of renewable energy production datasets 208. Further, the processor 202 of the central cloud server 102 may be configured to generate the electronically verifiable span data package 212 by assigning a timestamp and a hash value to each of the plurality of renewable energy production datasets 208. The electronically verifiable span data package 212 is processed to generate the REC claim request in a defined taxonomy compatible to be read by the API 122 of the first third-party system 120 associated with the renewable energy verifier entity 106. The processor 202 may be further configured to trigger and communicate a REC claim request to the first third-party system 120 along with a portion of the electronically verifiable span data package 212 as evidence. The processor 202 may be further configured to execute a local pre-validation of the plurality of renewable energy production datasets 208 acquired from the renewable energy metering and monitoring device 104A using one or more defined checkpoints prior to verification of the REC claim request by the first third-party system 120. On successful verification of the REC claim request, the processor 202 may further be configured to acquire a unique identifier associated with a first REC from the first third-party system 120. The processor 202 may further be configured to generate the interactive DIGIREC asset 218 based on the predefined REC-taxonomy metadata 216 and the acquired unique identifier, where the interactive DIGIREC asset 218 is associated with an ownership to the registered entity 126 of the renewable energy production source site 118.

In addition, the processor 202 may be configured to track a redeemed status of the interactive DIGIREC asset 218 based on one or both of: a confirmation from an electronic renewable energy exchange platform that indicates a successful redemption or an expiry of a defined validity period. Further, the processor 202 of the central cloud server 102 may be configured to tag the interactive DIGIREC asset 218 as no longer available at the central cloud server 102 or the renewable energy exchange platform for further use after receiving the confirmation of the successful redemption or after the expiry of the defined validity period. The processor 202 may be configured to embed the ancillary information 220 in an encrypted form in the interactive DIGIREC asset 218.

FIG. 3A is a diagram illustrating various exemplary components of a renewable energy metering and monitoring device, in accordance with an embodiment of the present disclosure. FIG. 3A is described in conjunction with the elements of FIGS. 1 and 2. With reference to FIG. 3A, there is shown a block diagram 300 of the renewable energy metering and monitoring device 104A that may include a network interface 302, a data acquisition circuit 304, a meter 306, a sensor circuit board 308 a controller 310 and a memory 312. In an implementation, the memory 312 may be configured to store on-the-ground ambient conditions 314.

The network interface 302 may include suitable logic, circuitry, and/or interfaces that is configured to establish a communication channel with the one or more inverters 116 at the renewable energy production source site 118.

The data acquisition circuit 304 may be configured to acquire raw renewable energy production data as electricity is generated from one or more renewable energy generation devices at the renewable energy production source site 118 based on data signals directly obtained from the one or more inverters 116 over the established communication channel. The data acquisition circuit 304 enables monitoring of the renewable energy generation. The data acquisition circuit 304 may be configured to proactively detect any fluctuations in the renewable energy production.

The meter 306 may be a smart meter configured to monitor and record the amount of renewable energy generated, along with the date and duration of renewable energy generation. The meter 306 may also be referred to as a smart electrical meter. The meter 306 and the data acquisition circuit 304 are connected in a transmission line with the AC electricity produced and transmitted by the one or more inverters 116. The meter 306 may be configured to measure the electricity in a live fashion as it is generated and passes through the transmission line. In some configurations, if the arrangement is such that the locally generated electricity is used by the same facility (i.e., the renewable energy production source site 118) before being transmitted to an electrical grid (captive needs), still the meter 306 may read and capture the electricity generated. The meter 306 may ensure the accuracy and reliability of the renewable energy production data by directly monitoring the AC electricity produced by the one or more inverters 116.

The sensor circuit board 308 may include one or more sensors configured to generate sensor information indicative of the on-the-ground ambient conditions 314 that exist during renewable energy production at the renewable energy production source site 118 influencing production of renewable energy. Examples of the one or more sensors may include, but are not limited to, weather sensors, air quality sensors, wind speed sensors, air temperature sensors, connection status sensors, and the like.

The controller 310 may be configured to communicate the plurality of renewable energy production datasets 208 to the central cloud server 102 where they are processed for verification and issuance of the interactive DIGIREC asset 218. Examples of the controller 310 may include, but are not limited to, a processor, an integrated circuit, a co-processor, a microprocessor, a microcontroller, a complex instruction set computing (CISC) processor, an application-specific integrated circuit (ASIC) processor, a reduced instruction set (RISC) processor, a very long instruction word (VLIW) processor, a central processing unit (CPU), a state machine, a data processing unit, and other processors or circuits. Moreover, the controller 310 may refer to one or more individual processors, processing devices, a processing unit that is part of a machine.

The memory 312 may include suitable logic, circuitry, interfaces and/or code that is configured to store machine code and/or instructions executable by the controller 310. In an implementation, the memory 312 may be configured to store the plurality of renewable energy production datasets 208, the electronically verifiable span data package 212, a first detection value indicative of a device-to-device connection between the renewable energy metering and monitoring device 104A and the one or more inverters 116 and a second detection value indicative of physical protection for secured access to the renewable energy metering and monitoring device 104A. Examples of implementation of the memory 312 are similar to that of the primary storage 206 of the central cloud server 102. The memory 312 of the renewable energy metering and monitoring device 104A may be configured to store all the elements that are stored by the primary storage 206 of the central cloud server 102 (of FIG. 2), for example, the DIGIREC wallet 224, DIGIREC registry 226, DIGIREC reporting 228, and the like.

In operation, the network interface 302 of the renewable energy metering and monitoring device 104A may be configured to establish the communication channel with the one or more inverters 116 at the renewable energy production source site 118. By virtue of the network interface 302, the renewable energy metering and monitoring device 104A manifests the ability to communicate with the one or more inverters 116, installed at the renewable energy production source site 118, in order to acquire, monitor and track the AC energy produced by the one or more inverters 116. In an implementation, each of the one or more inverters 116 may have a digital port to provide live continuous energy production information and related data to the renewable energy metering and monitoring device 104A. Moreover, the renewable energy metering and monitoring device 104A may be configured to be adapted to the renewable energy production data received from the one or more inverters 116 if the one or more 116 are configured to provide the data periodically. The network interface 302 enables the renewable energy metering and monitoring device 104A to access and retrieve the stored data from the one or more inverters 116. The establishment of the communication channel between the renewable energy metering and monitoring device 104A and the one or more inverters 116 enables seamless data transfer and retrieval. This ensures the accurate measurement and recording of the amount of energy generated, the time of generation, and the identification information. Moreover, the establishment of the communication channel facilitates the reliable and verifiable data exchange between the renewable energy metering and monitoring device 104A and the one or more inverters 116, which has significance for issuing valid Renewable Energy Certificates and maintaining transparency in renewable energy production.

The data acquisition circuit 304 may be configured to acquire raw renewable energy production data as electricity is generated from one or more renewable energy generation devices at the renewable energy production source site 118 based on data signals directly obtained from the one or more inverters 116 over the established communication channel. The data signals may include information, such as the amount of renewable energy generated, the time-period of renewable energy generation, and identification details of the one or more inverters 116. Thereafter, the data acquisition circuit 304 of the renewable energy metering and monitoring device 104A may be configured to read the acquired raw renewable energy production data as and when electricity is generated from the list of renewable energy generation devices 114 at the renewable energy production source site 118. The data acquisition circuit 304 may be configured to read the raw renewable energy production data in real-time based on data signals directly obtained from the one or more inverters 116 over the established communication channel. The real-time reading of the raw renewable energy production data enables the renewable energy metering and monitoring device 104A to proactively detect and respond to any fluctuations in renewable energy production. The acquired raw renewable energy production data may be used to create a digital twin of the renewable energy production data. The digital twin serves to substantiate and authenticate the production of electricity from the list of renewable energy generation devices 114. Additionally, the digital twin may be used to validate other underlying or related data, such as the location and time of renewable energy production. By having the digital twin of the renewable energy production data, it becomes easy to track and verify renewable energy production, ensuring transparency and accountability. By directly obtaining the data signals from the one or more inverters 116 using the data acquisition circuit 304, the renewable energy metering and monitoring device 104A ensures real-time and reliable data acquisition.

In accordance with an embodiment, the network interface 302 of the renewable energy metering and monitoring device 104A is connected to a corresponding data port of the one or more inverters 116 to securely obtain the data signals from the one or more inverters 116 over the established communication channel. The connection of the network interface 302 of the renewable energy metering and monitoring device 104A to the corresponding data port of the one or more inverters 116 provides a real-time feed of AC form of electricity obtained from the renewable energy generation at the renewable energy production source site 118. Moreover, the connection of the network interface 302 of the renewable energy metering and monitoring device 104A to the corresponding data port of the one or more inverters 116 ensures the privacy of the data signals obtained from the one or more inverters 116 over the established communication channel. By securely obtaining the data signals from the one or more inverters 116, the renewable energy metering and monitoring device 104A can accurately monitor and track the amount of energy generated from the list of renewable energy generation devices 114.

Furthermore, the meter 306 of the renewable energy metering and monitoring device 104A may be configured to monitor and record the amount of renewable energy generated as well as the date and the duration for which the renewable energy is generated. In an implementation, the meter 306 may be configured to monitor the actual performance (i.e., the performance of the one or more inverters 116 by monitoring the electricity generated in form of AC through renewable energy generation using the list of renewable energy generation devices 114 at the renewable energy production source site 118) in real time and record historic and current performance of the one or more inverters 116.

By monitoring and recording the amount of energy generated, along with the date and duration of generation in a live fashion, the renewable energy metering and monitoring device 104A provides a trusted resource for accountability of renewable energy certificates. By monitoring and recording the amount of renewable energy generated, the meter 306 may ensure the accuracy and reliability of the renewable energy production data. The amount of renewable energy recorded by the meter 306 may be used for future performance analysis of, for example, the list of renewable energy generation devices 114 and forecasting of future renewable energy production.

The sensor circuit board 308 is connected to the data acquisition circuit 304 and the meter 306, where the sensor circuit board 308 is communicatively coupled to one or more sensors configured to generate sensor information indicative of on-the-ground ambient conditions 314 that exist during renewable energy production at the renewable energy production source site 118 influencing the production of renewable energy.

The on-the-ground ambient conditions 314 may have a direct impact on the production of renewable energy. The on-the-ground ambient conditions 314 may include a weather condition, an air quality condition, a wind speed parameter, an air temperature parameter, and the like. The purpose of generating the sensor information is to substantiate and authenticate the production of renewable energy, as well as other related data such as the location and time of production. By monitoring the on-the-ground ambient conditions 314, the renewable energy metering and monitoring device 104A ensures the accurate tracking, validation, and verification of renewable energy production. The sensor information has a great significance for maximizing renewable energy generation and making informed decisions regarding appropriate equipment selection for renewable energy generation at a commercial scale.

In accordance with an embodiment, the on-the-ground ambient conditions 314 comprises one or more of: a weather condition, an air quality or pollution condition, a wind speed parameter, an air temperature parameter, an atmospheric pressure condition, a terrain condition, a relative humidity (RH) condition, a rainfall condition, a precipitable water condition, a Snow Days (SD) condition, a CoolingDegree Days (CDDs) condition, and a HeatingDegree Days (HDDs) condition. The on-the-ground ambient conditions 314 may include ambient temperature conditions, ambient light conditions, ambient climate conditions, ambient environmental conditions, ambient weather conditions, and the like. The on-the-ground ambient conditions 314 at the renewable energy production source site 118 either directly or indirectly impact the production of the renewable energy. By generating the sensor information indicative of the on-the-ground ambient conditions 314, such as weather, air quality, wind speed, air temperature, atmospheric pressure, terrain, relative humidity, rainfall, precipitable water, Snow Days, CoolingDegree Days, and HeatingDegree Days, the renewable energy metering and monitoring device 104A provides a comprehensive data for assessing the impact of these conditions on renewable energy generation. This information can be used to maximize energy production and make informed decisions regarding renewable energy systems.

In accordance with an embodiment, the on-the-ground ambient conditions 314 further comprises a first detection value indicative of whether a device-to-device connection between the renewable energy metering and monitoring device 104A and the one or more inverters 116 is maintained or lost, and if lost, then record a duration of loss of the device-to-device connection. The device-to-device connection between the renewable energy metering and monitoring device 104A and the one or more inverters 116 has significance for accurate and reliable monitoring of renewable energy generation. The recording of the duration, in case of any loss of the device-to-device connection, supports identifying potential issues or disruptions in the energy generation process. Additionally, the recorded duration of the loss of the device-to-device connection provides valuable insights into the stability and reliability of the renewable energy metering and monitoring device 104A.

In accordance with an embodiment, the on-the-ground ambient conditions 314 further comprises a second detection value indicative of whether physical protection for secured access to the renewable energy metering and monitoring device 104A is breached and a logged access time. The inclusion of the second detection value for breached physical protection is required to ensure the security and integrity of the renewable energy metering and monitoring device 104A. By detecting any unauthorized access attempts, the renewable energy metering and monitoring device 104A can prevent tampering or unauthorized manipulation of renewable energy production data, which the renewable energy metering and monitoring device 104A collects. The inclusion of the second detection value provides an additional layer of protection against potential breaches, ensuring the accuracy and reliability of the collected data. Additionally, the logged access time allows for tracking and auditing of access events, further enhancing accountability and trust in the operation of the renewable energy metering and monitoring device 104A.

The controller 310 of the renewable energy metering and monitoring device 104A may be configured to communicate the plurality of renewable energy production datasets 208 to the central cloud server 102. In response, the central cloud server 102 may be configured to generate the electronically verifiable span data package 212 from the plurality of renewable energy production datasets 208 and process the electronically verifiable span data package 212 to generate a REC claim request in a defined taxonomy compatible to be read by the API 122 of the first third-party system 120 associated with the renewable energy verifier entity 106. The electronically verifiable span data package 212 is generated to provide the trusted resource for accountability of renewable energy certificates. By organizing the REC claim request in the defined taxonomy and making them compatible with the API 122 of the first third-party system 120, the central cloud server 102 enables the exchange and verification of data that supports or proves the corresponding Renewable Energy Certificate for Electricity (REC(E)). By using a portion of the electronically verifiable span data package 212 as evidence along with the REC claim request, the trust deficit issues associated with the conventional analog-based systems may be addressed and the integrity and accuracy of the renewable energy certification process may be ensured. By providing an automated assurance construct and continuous confirmation by an independent third-party system (i.e., the first third-party system 120, the renewable energy metering and monitoring device 104A enhances the integrity, accuracy, and scalability of the renewable energy certification process.

In accordance with an embodiment, the controller 310 of the renewable energy metering and monitoring device 104A is further configured to ascertain whether the raw renewable energy production data is aligned with the sensor information indicative of the on-the-ground ambient conditions 314. The alignment of the raw renewable energy production data with the sensor information indicative of the on-the-ground ambient conditions 314 is checked in order to provide a trusted resource for accountability of renewable energy certificates. The conventional renewable energy certification process operates on the basis of trust, relying on analog-based reporting methods. However, the conventional analog-based process lacks continuous confirmation by the independent third-party and has led to integrity and accuracy issues. In contrast to the conventional methods, the renewable energy metering and monitoring device 104A ensures a more reliable and verifiable method for tracking, validating, and verifying renewable energy production.

In accordance with an embodiment the controller 310 of the renewable energy metering and monitoring device 104A is further configured to communicate supplementary information to the central cloud server 102, where the supplementary information comprises a location of the renewable energy production source site 118, a fuel type indicative of a type of renewable energy used, device information of the list of renewable energy generation devices 114 and the one or more inverters 116 located at the renewable energy production source site 118, where the central cloud server 102 is further configured to utilize the supplementary information for the generation of the electronically verifiable span data package 212. The communication of the supplementary information to the central cloud server 102 may provide the supplementary information accessible for review and verification by relevant parties, such as the renewable energy verifier entity 106. The supplementary information may be utilized for generating the electronically verifiable span data package 212 in order to ensure accurate and reliable monitoring of renewable energy generation. Moreover, by incorporating the supplementary information in the electronically verifiable span data package 212 at granular level, such as the location of the renewable energy production source site 118, the fuel type indicative of the type of renewable energy used, device information of the list of renewable energy generation devices 114 and the one or more inverters 116, the electronically verifiable span data package 212 enhances the transparency and credibility of renewable energy certificates.

In accordance with an embodiment, the controller 310 is further configured to execute a local pre-validation of the plurality of renewable energy production datasets 208 using one or more defined checkpoints prior to communication to the central cloud server 102. The local pre-validation of the plurality of renewable energy production datasets 208 means the controller 310 may be configured to check various aspects, such as the time, the duration, IP addresses, identification details of the renewable energy generation devices 114, make and model, and grid connection status of the renewable energy production source site 118. The local pre-validation of the plurality of renewable energy production datasets 208 is performed in order to ensure the trustworthiness and reliability of the renewable energy production data before being communicated to the central cloud server 102. By performing the local pre-validation of the plurality of renewable energy production datasets 208, the renewable energy metering and monitoring device 104A can identify inaccuracies, deficiencies, or potential manipulation of the plurality of renewable energy production datasets 208. The local pre-validation of the plurality of renewable energy production datasets 208 enables the renewable energy metering and monitoring device 104A to address the integrity and accuracy issues associated with the conventional analog-based renewable energy certificates and ensures that the reported energy production is substantiated with actual production evidence.

In accordance with an embodiment, the controller 310 of the renewable energy metering and monitoring device 104A is further configured to determine an on-the ground performance of the list of renewable energy generation devices 114 based on the sensor information. By continuously determining the on-the-ground performance of the list of renewable energy generation devices 114, the renewable energy metering and monitoring device 104A may have the ability to provide the trusted resource for accountability of renewable energy certificates and address the integrity and accuracy issues associated with the conventional analog-based systems for renewable energy certification. By automating the assurance construct and continuously determining the on-the-ground performance of the list of renewable energy generation devices 114, the renewable energy metering and monitoring device 104A may address trust deficit issues, ensure accuracy in carbon emissions monitoring, and provide a reliable system for renewable energy suppliers.

In accordance with an embodiment, a renewable energy certificate (REC) claim request is generated and communicated by the central cloud server 102 to the first third-party system 120 along with a portion of the electronically verifiable span data package 212 as evidence, which is further used to issue the first REC when the REC claim request is successfully verified. By utilizing the portion (i.e., the evidence information or source evidence file) of the electronically verifiable span data package 212 as evidence for the REC claim request and enabling third-party verification (i.e., verification by the first third-party system 120)), the renewable energy metering and monitoring device 104A along with the central cloud server 102 provides a more reliable and transparent approach to issuing renewable energy certificates. The use of the portion of the electronically verifiable span data package 212 as evidence along with the REC claim request addresses various issues associated with the conventional analog-based systems, such as lack of integrity, data manipulation, and the like. The use of the renewable energy metering and monitoring device 104A, the central cloud server 102, and third-party systems (i.e., the first third-party system 120) with the extracted portion of the electronically verifiable span data package 212 enable the generation and verification of the REC claim request. This ensures that the generated REC claim requests are based on actual renewable energy production or carbon reduction activities, providing a trusted resource for the accountability of renewable energy certificates. After verification of the REC claim request, the first third-party system 120 associated with the REC issuing entity 108 may be configured to acquire a unique identifier of the first REC (issued by the REC issuing entity 108) and communicate the unique identifier of the first REC to the central cloud server 102.

In accordance with an embodiment, a unique identifier associated with the first REC is acquired and converted to the interactive digital renewable energy certificate (DIGIREC) asset 218 based on the predefined REC-taxonomy metadata 216 stored at the central cloud server 102, and where the interactive DIGIREC asset 218 is a digital exchangeable energy attribute certificate based asset that provides an assurance of authenticity about the production of a unit of electricity through renewable energy through an objective digital evidence chain of custody based on a multi-layered verification of renewable energy production corresponding to the plurality of renewable energy production datasets 208. The acquired unique identifier serves as a reference to the specific REC (i.e., the first REC), allowing for accurate tracking and verification of renewable energy produced at the renewable energy production source site 118. The conversion of the acquired unique identifier associated with the first REC to the interactive DIGIREC asset 218 is done to provide a trusted resource for the accountability of renewable energy certificates. The digitization of the renewable energy certificates eliminates the reliance on the conventional analog or manual-based approach of issuing the renewable energy certificates that operate on trust alone. This way, the trust deficit issues that may exist from new, small, unfamiliar, or geographically distanced renewable energy suppliers may be addressed. The interactive DIGIREC asset 218 addresses the limitations and issues associated with existing analog-based renewable energy certificates. The conventional analog certificates rely on trust and self-authentication, which lead to inaccuracies, lack of integrity, and manipulation. The use of the interactive DIGIREC asset 218 and the objective digital evidence chain of custody ensures the accuracy and integrity of renewable energy production data.

FIG. 3B is a diagram illustrating various exemplary components of a renewable energy metering and monitoring device, in accordance with another embodiment of the present disclosure. FIG. 3B is described in conjunction with the elements of FIGS. 1, 2 and 3A. With reference to FIG. 3B, there is shown the renewable energy metering and monitoring device 104A comprising the data acquisition circuit 304, the meter 306, and the sensor circuit board 308. There is further shown a locking mechanism 316 provided on the renewable energy metering and monitoring device 104A.

The locking mechanism 316 provided on the renewable energy metering and monitoring device 104A prevents access of the renewable energy metering and monitoring device 104A to any individual either working at the renewable energy production source site 118 or outside of the system 100. In case, if any individual tries to access the renewable energy metering and monitoring device 104A, the locking mechanism 316 may be configured to send a warning signal to the user 110 working at the renewable energy production source site 118. In an implementation, the locking mechanism 316 may be a smart locking mechanism that can be controlled remotely using a smart phone application. The smart locking mechanism may offer various features, such as keyless entry, activity logs and the like. In another implementation, the locking mechanism 316 may be an electronic locking mechanism, which uses electronic components, such as keypads, radio frequency identification (RFID) card or biometric scanner to control access. Examples of implementation of the locking mechanism 316 are, but not limited to, a pin tumbler locking mechanism, deadbolt locking mechanism, combination locking mechanism, cam locking mechanism, knob locking mechanism, and the like.

Each of the data acquisition circuit 304, the meter 306, and the sensor circuit board 308 are internally connected to each other. In an implementation, the data acquisition circuit 304 may have a display device (e.g., LCD or LED) to display the raw renewable energy production data in form of data signals and few knob controls in order to observe the minute details of the information carried by the data signals.

In an implementation, the sensor circuit board 308 may be in form of a printed circuit board (PCB), coupled to the one or more sensors. Examples of the one or more sensors to detect the on-the-ground ambient conditions 314 include, but are not limited to: anemometers and wind vanes for measuring wind speed and direction; rain gauge and disdrometer for measuring precipitation and rainfall; thermometers, thermistors, or resistance temperature detectors (RTDs) for measuring air temperature; barometers or pressure transducers for measuring atmospheric pressure; hygrometers or capacitive humidity sensors for measuring relative humidity (RH); particulate matter (PM) sensors and gas sensors (e.g., CO, NO2, SO2, O3) for measuring air quality and pollution; pyranometers for measuring solar radiation; lidar, radar, or stereo vision cameras for measuring terrain conditions; microwave radiometers or sun photometers for measuring precipitable water; snow depth sensors or remote sensing techniques (e.g., satellite imagery) for measuring Snow Days (SD) conditions; and site-specific temperature data-derived calculations for CoolingDegree Days (CDDs) and HeatingDegree Days (HDDs) conditions. Some sensors may be mounted on the sensor circuit board 308 and some sensors may be installed on the renewable energy production source site 118. The sensor circuit board 308 may have wireless antennas to receive the sensor information from the sensors installed at the renewable energy production source site 118. The sensor information is indicative of the on-the-ground ambient conditions 314 that exist during renewable energy production at the renewable energy production source site 118 and influence the production of renewable energy. The on-the-ground ambient conditions 314 are described in detail, for example, in FIG. 3C.

The meter 306 may be configured to store and display the units of electricity obtained from the generated renewable energy along with the date and the duration for which the renewable energy is generated.

FIG. 3C is a diagram illustrating various on-the-ground ambient conditions that exist during renewable energy production at a renewable energy production source site, in accordance with an embodiment of the present disclosure. FIG. 3C is described in conjunction with the elements of FIGS. 1, 2, 3A, and 3B. With reference to FIG. 3C, there is shown the sensor circuit board 308 comprising one or more sensors 318. The one or more sensors 318 are shown in the sensor circuit board 308 for sake of brevity. Although, a few sensors of the one or more sensors 318 may be mounted on the sensor circuit board 308 and few sensors of the one or more sensors 318 may be installed at the renewable energy production source site 118, which are communicatively coupled to the sensor circuit board 308. The one or more sensors 318 may be configured to generate the sensor information indicative of the on-the-ground ambient conditions 314 that exist during renewable energy production at the renewable energy production source site 118 and impact the production of renewable energy. The on-the-ground ambient conditions 314 may include a weather condition 314A, an air quality or pollution condition 314B, a wind speed parameter 314C, an air temperature parameter 314D, an atmospheric pressure condition 314E, a terrain condition 314F, a relative humidity (RH) condition 314G, a rainfall condition 314H, a precipitable water condition 314I, a Snow Days (SD) condition 314J, a CoolingDegree Days (CDDs) condition 314K, and a HeatingDegree Days (HDDs) condition 314L. Additionally, the on-the-ground ambient conditions 314 includes the first detection value and the second detection value, have been described in detail, for example, in FIG. 3A. Furthermore, the controller 310 of the renewable energy metering and monitoring device 104A may be configured to execute a local pre-validation 320 on the on-the-ground ambient conditions 314 to check the alignment of the raw renewable energy production data with the sensor information indicative of the on-the-ground ambient conditions 314 and determine an on-the ground performance of the list of renewable energy generation devices 114 based on the sensor information.

FIG. 4 is a diagram illustrating an electronically verifiable span data package, in accordance with an embodiment of the present disclosure. FIG. 4 is described in conjunction with elements of FIGS. 1, 2, 3A, 3B and 3C. With reference to FIG. 4, there is shown the electronically verifiable span data package 212 that may include a first type of data item 402 and a second type of data item 404.

The first type of data item 402 may have a first data structure 414 with different values and data extensions (e.g., a first value 406A, a second value 406B, a third value 406C, a first data extension 408A, a second data extension 408B, a version placeholder 410, a monitoring, reporting and verification (MRV) extension, simply referred to as MRV extension 412). The second type of data item 404 may be an evidence file that may include different data sources and corresponding data files (e.g., a first source 416A, a second source 416B, a third source 416C, a first data file 418A, a second data file 418B and a third data file 418C). The first data file 418A may be associated with the first source 416A, the second data file 418B may be associated with the second source 416B and the third data file 418C may be associated with the third source 416C.

The first type of data item 402 and the second type of data item 404 may be stored as a checkpoint, which is a tamper-resilient record of the renewable energy data production data associated with the one or more inverters 116 and the list of renewable energy generation devices 114 (of FIG. 1). The checkpoint can be structured to be the data values, structure, and amount of data that is specified as a predetermined structure that meets the requirement for a particular REC claim. A portion of the electronically verifiable span data package 212 may be used for submission as evidence and checkpoint for the REC claim. In an implementation, the first type of data item 402 may further include the REC claim information details, such as a claim date of the REC claim request, a checkpoint source, a data structure related to the defined taxonomy, a fuel type indicative of a type of renewable energy used, a production capacity of the renewable energy production source site 118, an identifier of the renewable energy production source site 118, and an account information associated with the renewable energy production source site 118 assigned by the renewable energy verifier entity 106.

The first value 406A, the second value 406B and the third value 406C may be a specific data type within the first type of data item 402. In addition, each of the first data extension 408A and the second data extension 408B may be configured to store additional information associated with the first type of data item 402. In an implementation, each of the first data extension 408A and the second data extension 408B may provide supplementary information relevant to an the relevant REC issuing entity code or methodology used in the REC-claim.

The version placeholder 410 may refer to a defined number of a data format being used in the first type of data item 402. In an example, a version “1.0” may suggest that this is the first version of the first type of data item 402. In addition, the MRV extension 412 may be a specific type of data extension which is used for monitoring, reporting and verification (MRV) purposes. In an implementation, the MRV extension 412 may provide details relevant to the relevant REC issuing entity code used for the issuance of the interactive DIGIREC asset 218.

In an example, a structure of the first type of data item 402 may be described as shown in Table 1:

TABLE 1
The first type of data item 402

```
      {
      “manifest”: {
          “id”: “ab0ec8e8-6cd0-40b7-92b7-cbae0d08ae37”,
          “version”: “1.0”,
          “aioId”: “0117417a-9763-48e1-88e8-6a7e937c3cb1”,
          “aimId”: “3e343ef2-e700-4b34-a23f-5a6499004ede”,
          “claimId”: “15ed8e5c-b05a-4bc6-adf5-9dac98bfea00”,
          “projectDeveloperId”: “f5d17f74-95f7-4178-9206-9f3bffc3b736”,
          “created”: {
        “date”: {
          “dateString”: “2023-11-27”
        }
          },
          “mrvExtensions”: [
{
  “mrvExtensionContext”: “SDP_MANIFEST_MRV_EXTENSION”,
  “untypedExtension”: {
    “name”: “C-Pesa REC Data Extension”,
    “version”: “1.0”,
    “description”: “C-Pesa REC Data Extension holds data values specific to the REC code or
  methodology being followed.”,
    “dataExtensions”: [
  {
    “key”: “Checkpoint Source”,
    “value”: “Inverter: 147e7105-2333-4f5f-847c-6c984e5220dd: m350206220”
  }
            “sdpFiles”: [
        {“name”: “147e7105-2333-4f5f-847c-6c984e5220dd.json”,
          “type”: “DATA_JSON”,
          “description”: “Evidence from C-Pesa Box: m350206220”,
          “claimSourceId”: “147e7105-2333-4f5f-847c-6c984e5220dd”,
          “claimSourceAttestation”: “digital signature”,
          “mrvExtensions”: [
            {
          “mrvExtensionContext”: “AIM_CLAIM_SOURCE_MRV_EXTENSION”,
          “untypedExtension”: {
            “name”: “C-Pesa-Device”,
            “version”: “1.0.0”,
            “description”: “C-Pesa Verifier_ Device Extension to hold values needed for Verifier_{—}
      for Registered Devices in ECS”,
            “dataExtensions”: [
              {
            “key”: “ResourceValuesToQuery”,
            “value”:
      “device_id,values_id,e_03_07_00_999_Planned_Energy_Output,e_00_02_00_001_AC
      _voltage,e_00_03_00_001_AC_current,e_00_05_00_001_AC_activepower,e_00_02_0
      0_001_DC_busvoltage,i_00_06_00_001_Syn_frequency,e_00_16_00_001_operatingti
      me,e_00_16_00_001_total_runningtime,e_03_07_00_001_power_consumption,e_03_0
      1_00_000_total_solar_power,e_03_01_00_000_total_other_power,e_03_07_04_000_to
      tal_load_energy,e_03_07_04_001_AC_import_energy,e_03_07_04_001_AC_export_e
      nergy,e_03_08_04_001_AC_import_reactiveenergy,e_03_08_04_001_AC_export_reac
      tiveenergy,e_03_07_00_003_AC_energy,e_03_07_00_003_AC_energy_daily,e_00_16
      _00_003_inverter_runningtime,e_00_16_00_003_inverter_feedintime”
              },
              {
            “key”: “Verifier_Properties”,
            “value”: “v1.0”,
            “data”: [
              { “key”: “Verifier_DeviceId”,
                “value”: “OJIJES10001”
              },
              {
                “key”: “Verifier_DeviceUId”,
                “value”: “01HA7GH8Y9CD7AEDY40SVP1AMF”
              {
                “key”: “Verifier_DeviceName”,
                “value”: “Ojijo_Device_1”
              },
              {
                “key”: “Verifier_FuelType”,
                “value”: “ES-100 Solar”
              },
              {
                “key”: “Verifier_DeviceTechnology”,
                “value”: “TC110 - PV Ground mounted”
              },
              {
                “key”: “Verifier_DeviceCapacity”,
                “value”: “2.00000 MW”
              },
              {
                “key”: “Verifier_CommissioningDate”,
                “value”: “2023/07/01”
              },
              {
                “key”: “Verifier_DefaultAccountCode”,
                “value”: “ETAP92WN”
            {
          “mrvExtensionContext”:
          “mrvExtensionContext”: “SDP_FILE_MRV_EXTENSION”,
          “untypedExtension”: {
            “name”: “ECS Span Data Package File Metadata”,
            “version”: “1.0.0”,
            “description”: “Basic file information for an ECS Span Data Package”,
            “dataExtensions”: [
              {
            “key”: “File Name”,
            “value”: “147e7105-2333-4f5f-847c-6c984e5220dd.json”
              },
              {
            “key”: “File Size”,
            “value”: “544481”
              },
              {
            “key”: “File Type”,
            “value”: “.json”
              },
              {
            “key”: “File Created”,
            “value”: “11/27/2023 20:57:49”
              },
              {
            “key”: “File Modified”,
            “value”: “11/27/2023 20:57:49”
              },
              {
            “key”: “File Accessed”,
            “value”: “11/27/2023 20:57:49”
              }
```

In the above example, the first type of data item 402 may include information about the REC claim that was created on Nov. 27, 2023. The claim ID is 15ed8e5c-b05a-4bc6-adf5-9dac98bfea00. The source data file is named “147e7105-2333-4f5f-847c-6c984e5220dd.json” and it contains data from the one or more inverters 116.

The second type of data file 404 may include the evidence to support the REC claim. The second type of data item 404 may include a list of device identities (IDs) and corresponding renewable energy production data associated with each device ID over a specified period as source evidence. The source evidence may come from a variety of sources, such as the first source 416A, the second source 416B and the third source 416C. The first source 416A, the second source 416B and the third source 416C may provide an origin of the second type of data item 404. The first source 416A, the second source 416B and the third source 416C may be a device, or a system that generates the second type of data item 404. In addition, the first data file 418A, the second data file 418B and the third data file 418C may include renewable energy production data. The renewable energy production data is associated with the one or more inverters 116 and the list of renewable energy generation devices 114 for a specific period.

In an example, a structure of the second type of data item 404 may be described as shown in Table 2:

TABLE 2
The second type of data item 404

```
{
  “data”: [
    {
  “timestamp”: “2023-11-05T00:00:52+00:00”,
  “device_id”: “m350206136”,
  “values_id”: “001”,
  “e_03_07_04_001_AC_import_energy”: 0.099,
  “e_03_07_04_001_AC_export_energy”: 1040.128,
  “e_03_08_04_001_AC_import_reactiveenergy”: 0.394,
  “e_03_08_04_001_AC_export_reactiveenergy”: 14.875
    },
{
  “timestamp”: “2023-11-05T00:03:11+00:00”,
  “device_id”: “m350206136”,
  “values_id”: “001”,
  “e_03_07_04_001_AC_import_energy”: 0.099,
  “e_03_07_04_001_AC_export_energy”: 1040.128,
  “e_03_08_04_001_AC_import_reactiveenergy”: 0.394,
  “e_03_08_04_001_AC_export_reactiveenergy”: 14.875
    },
    {
  “timestamp”: “2023-11-05T00:03:57+00:00”,
  “device_id”: “m350206136”,
  “values_id”: “000”,
  “e_03_01_00_000_total_solar_power”: 0.0
    },
    {
  “timestamp”: “2023-11-05T00:08:37+00:00”,
  “device_id”: “m350206136”,
  “values_id”: “000”,
  “e_03_01_00_000_total_solar_power”: 0.0
    },
    {
  “timestamp”: “2023-11-05T00:14:52+00:00”,
  “device_id”: “m350206136”,
  “values_id”: “001”,
  “e_03_07_04_001_AC_import_energy”: 0.099,
  “e_03_07_04_001_AC_export_energy”: 1040.128,
  “e_03_08_04_001_AC_import_reactiveenergy”: 0.394,
  “e_03_08_04_001_AC_export_reactiveenergy”: 14.876 }
```

The data structure of each of the first type of data item 402 and the second type of data item 404 provides the opportunity to retrieve the renewable energy production data at a later date, such as a month, year, etc. to review and confirm the underlying data that is the source of the verification (and the issued first REC). A third party, such as an auditor can be provided with access rights through a portal to check the data and verify that the hash and related are correct and properly verified. If there is an error, it can generate an indication that the source data is improperly manipulated or generated.

FIG. 5 is a diagram illustrating various features of an interactive DIGIREC asset, in accordance with an embodiment of the present disclosure. FIG. 5 is described in conjunction with elements of FIGS. 1, 2, 3A, 3B, 3C and 4. With reference to FIG. 5, there is shown various provenance functions, such as a renewable energy production provenance, correlated with sensor information 502 and the audit trail 222.

In an implementation, the interactive DIGIREC asset 218 may be visualized on a user interface (UI) 504. The UI 504 may be part of the front-end interface 112A and can be remotely accessed by a user using a user device when authorized by the central cloud server 102. A user may provide user input, for example, a voice command, or by pressing or clicking the interactive DIGIREC asset 218 to visualize and access various provenance functions associated with the interactive DIGIREC asset 218. Examples of the user input may include, but are not limited to, a mouse input, a keyboard input, a voice command, a biometric input, a sensor input, or any other input to the UI 504). Examples of the provenance functions include but are not limited to, the renewable energy production provenance correlated with sensor information 502, the registered entity 126, the audit trail 222, the renewable energy tracking database, the DIGIREC wallet 224 and the DIGIREC registry 226 associated with the interactive DIGIREC asset 218.

The renewable energy production provenance correlated with sensor information 502 may be displayed as an UI element when a user input is provided on the interactive DIGIREC asset 218. When the user input is provided on UI element corresponding to the renewable energy production provenance correlated with sensor information 502, an assurance of an authenticity and provenance about production of a unit of electricity through renewable energy as claimed in the interactive DIGIREC asset 218, may be provided at an atomic level. For example, renewable energy production provenance correlated with sensor information 502 may indicate granular information, such as identity of the renewable energy production source site 118, the identities of each of the one or more inverters 116, sensor information indicative of the on-the-ground ambient conditions 314 that exist during renewable energy production, such as wind speed, air pressure, humidity, temperature, solar radiations, terrain conditions, and the like, a timestamp and hash value assigned to each of the plurality of renewable energy production datasets 208, and how many kWh of electricity generated at which renewable energy production source site, each day. An exemplary structure of such information is shown in Table 3.

TABLE 3

| | Energy | Cumulative | On-the-Ground | Influence of On-the- | Data |
|---|---|---|---|---|---|
| | Production | Energy | Ambient | Ground Ambient | Assurance |
| Timestamp | (kWh) | (kWh) | Conditions | Conditions | Indicator |
| 2023-04-01 | 0.000 | 0.000 | Solar Irradiance: 0 | No energy | OK |
| 00:00:00 | | | W/m², Air | production due to | |
| | | | Quality: Good, | zero solar irradiance | |
| | | | Precipitable | at night, suitable air | |
| | | | Water: Low, Air | quality, low | |
| | | | Temperature: | precipitable water, | |
| | | | 18° C. | and cool air | |
| | | | | temperature | |
| 2023-04-01 | 6.250 | 6.250 | Solar Irradiance: | Moderate energy | OK |
| 00:15:00 | | | 500 W/m², Air | production due to | |
| | | | Quality: Good, | moderate solar | |
| | | | Precipitable | irradiance, good air | |
| | | | Water: Moderate, | quality, moderate | |
| | | | Air Temperature: | precipitable water, | |
| | | | 20° C. | and mild air | |
| | | | | temperature | |
| 2023-04-01 | 8.750 | 15.000 | Solar Irradiance: | Higher energy | OK |
| 00:30:00 | | | 600 W/m², Air | production due to | |
| | | | Quality: Good, | increased solar | |
| | | | Precipitable | irradiance, good air | |
| | | | Water: Low, Air | quality, low | |
| | | | Temperature: | precipitable water, | |
| | | | 22° C. | and mild air | |
| | | | | temperature | |
| . . . | . . . | . . . | . . . | . . . | . . . |
| 2023-04-01 | 10.000 | 490.000 | Solar Irradiance: | Lower energy | OK |
| 23:45:00 | | | 100 W/m², Air | production due to | |
| | | | Quality: | reduced solar | |
| | | | Moderate, | irradiance towards | |
| | | | Precipitable | the end of the day, | |
| | | | Water: High, Air | moderate air | |
| | | | Temperature: | quality, high | |
| | | | 18° C. | precipitable water, | |
| | | | | and cool air | |
| | | | | temperature | |
| 2023-04-02 | 8.750 | 498.750 | Solar Irradiance: 0 | No energy | OK |
| 00:00:00 | | | W/m², Air | production due to | |
| | | | Quality: Good, | zero solar irradiance | |
| | | | Precipitable | at night, suitable air | |
| | | | Water: Moderate, | quality, moderate | |
| | | | Air Temperature: | precipitable water, | |
| | | | 16° C. | and cool air | |
| | | | | temperature | |

Table 3 shows exemplary renewable energy production data at 15-minute intervals for one day in an example. The “Energy Production (kWh)” column displays the renewable energy generated during each 15-minute interval in kilowatt-hours (kWh). The “Cumulative Energy (kWh)” column keeps a running total of the energy produced, which reaches 1,000 kWh or 1 MW at the end of the day. Table 3 may also have separate columns representing the identities of the one or more inverters 116, the identity of the renewable energy production source site 118 and the identities of the renewable energy metering and monitoring device 104A. The “Ambient Conditions” column may have sensed values for solar irradiance, air quality, precipitable water, and air temperature at each timestamp. These values represent the environmental conditions on the ground (i.e., at the site-specific location) at the time of renewable energy production. Furthermore, each row may also have a unique hash value represented as a hexadecimal string. The hash values are intended to represent the output of a cryptographic hash function applied to the corresponding renewable energy production dataset by the central cloud server 102. The “Influence of On-the-Ground Ambient Conditions” column represents the impact of the on-the-ground ambient conditions 314 on the renewable energy generation at each timestamp. The “Data Assurance” column provides a consistent message to the user, indicating that the data is recorded by a certified meter (e.g., the meter 306) and data acquisition system (e.g., the data acquisition circuit 304), ensuring its accuracy and reliability. An “OK” is assigned to the “Data Assurance” column which signifies that no tampering is performed to the recorded data and the recorded data is verified by independent auditors.

In an implementation, the audit trail 222 may be further displayed as a UI element when a user input is provided on the interactive DIGIREC asset 218. When the user input is provided on UI element corresponding to the audit trail 222, a sequence of audit associated with renewable energy production claimed in the interactive DIGIREC asset 218, may be validated. For example, identity of the renewable energy verifier entity 106, verification timestamp indicating when audit was done, an audit log may be accessed in addition to the information provided by the renewable energy production provenance correlated with sensor information 502, as shown in Table 3. In an exemplary scenario, the audit log may include the information related to different audits performed at various levels, for example, audit 0, audit 1, audit 2, audit 3 and audit 4. For example, the “audit 0” may correspond to the physical audit, which may be done initially to confirm whether the registration of each of the list of renewable energy generation devices 114, and the one or more inverters 116 at the renewable energy production source site 118 is accurately performed or not. The “audit 0” may also include the audition of the installation of the renewable energy metering and monitoring device 104A at the renewable energy production source site 118. Similarly, the next audit “audit 1” may correspond to the local pre-validation of the plurality of renewable energy production datasets 208 acquired from the renewable energy metering and monitoring device 104A using one or more defined checkpoints prior to verification of the REC claim request by the first third-party system 120. The “audit 2” may correspond to the audit done by the first third-party system 120 associated with the renewable energy verifier entity 106 to verify the REC claim request successfully. The “audit 3” may correspond to the audit done by the first third-party system 120 associated with the REC issuing entity 108 for issuing a unique identifier associated with the first REC. The “audit 4” may correspond to the audit done automatically by the central cloud server 102 after embedding the ancillary information 220 in the interactive DIGIREC asset 218. The “audit 4” may also confirm the successful embedding of the ancillary information 220 to the interactive DIGIREC asset 218.

The information associated with the different registered entities including country name may be stored, managed and accessed from the DIGIREC registry 226. Further, the DIGIREC wallet 224 may provide all the details related to different payment methods, websites or passwords used in trading of the interactive DIGIREC asset 218.

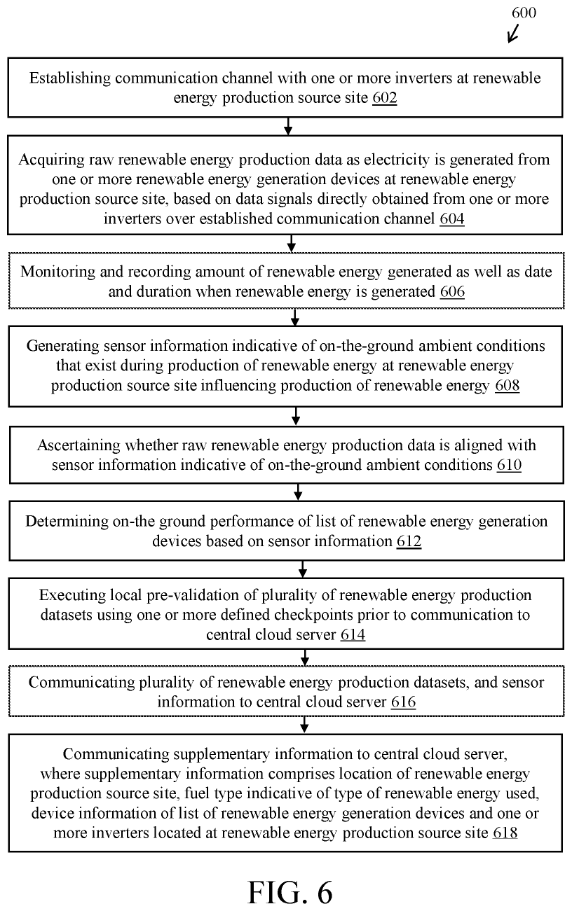

FIG. 6 is a diagram illustrating a flowchart of a method of tamper-resilient capture and verification of renewable energy production, in accordance with an embodiment of the present disclosure. FIG. 6 is described in conjunction with elements from FIGS. 1, 2, 3A, 3B, 3C, 4 and 5. With reference to the FIG. 6, there is shown a method 600 that includes steps 602 to 618. The renewable energy metering and monitoring device 104A (of FIG. 3A) may be configured to execute the method 600.

At 602, a communication channel with one or more inverters (e.g., the one or more inverters 116) at a renewable energy production source site (e.g., the renewable energy production source site 118) may be established. The network interface (i.e., the network interface 302) of the renewable energy metering and monitoring device 104A may be connected to a corresponding data port of the one or more inverters 116 to securely obtain the data signals from the one or more inverters 116 over the established communication channel.

At 604, raw renewable energy production data may be acquired as electricity is generated from one or more renewable energy generation devices at the renewable energy production source site 118 based on data signals directly obtained from the one or more inverters 116 over the established communication channel.

At 606, an amount of renewable energy generated as well as a date and a duration when the renewable energy is generated may be monitored and recorded.

At 608, sensor information indicative of on-the-ground ambient conditions (e.g., the on-the-ground ambient conditions 314 (of FIG. 3A)) that exist during the production of renewable energy at the renewable energy production source site 118 influencing the production of renewable energy may be generated. The on-the-ground ambient conditions 314 may comprise one or more of: a weather condition (e.g., the weather condition 314A), an air quality or pollution condition (e.g., the air quality or pollution condition 314B), a wind speed parameter (e.g., the wind speed parameter 314C), an air temperature parameter (e.g., the air temperature parameter 314D), an atmospheric pressure condition (e.g., the atmospheric pressure condition 314E), a terrain condition (e.g., the terrain condition 314F), a relative humidity (RH) condition (e.g., the RH condition 314G), a rainfall condition (e.g., the rainfall condition 314H), a precipitable water condition (e.g., the precipitable water condition 314I), a Snow Days (SD) condition (e.g., the SD condition 314J), a CoolingDegree Days (CDDs) condition (e.g., the CDDs condition 314K), and a HeatingDegree Days (HDDs) condition (e.g., the HDDs condition 314L). The on-the-ground ambient conditions 314 may further comprise a first detection value indicative of whether a device-to-device connection between the renewable energy metering and monitoring device 104A and the one or more inverters 116 is maintained or lost, and if lost, then record a duration of loss of the device-to-device connection. The on-the-ground ambient conditions 314 may further comprise a second detection value indicative of whether physical protection for secured access to the renewable energy metering and monitoring device 104A is breached and a logged access time.

At 610, the alignment of the raw renewable energy production data with the sensor information indicative of the on-the-ground ambient conditions 314 may be ascertained.

At 612, an on-the ground performance of a list of renewable energy generation devices (e.g., the list of renewable energy generation devices 114) may be determined based on the sensor information.

At 614, a local pre-validation of a plurality of renewable energy production datasets (e.g., the plurality of renewable energy production datasets 208 (of FIG. 2)) may be executed using one or more defined checkpoints prior to communication to a central cloud server (e.g., the central cloud server 102).

At 616, the plurality of renewable energy production datasets 208 and the sensor information may be communicated to the central cloud server 102.

At 618, a supplementary information may be communicated to the central cloud server 102, where the supplementary information comprises a location of the renewable energy production source site 118, a fuel type indicative of a type of renewable energy used, device information of the list of renewable energy generation devices 114 and the one or more inverters 116 located at the renewable energy production source site 118. The supplementary information may be utilized for generation of an electronically verifiable span data package (e.g., the electronically verifiable span data package 212) at the central cloud server 102.

The steps 602 to 618 are only illustrative and other alternatives can also be provided where one or more steps are added, one or more steps are removed, or one or more steps are provided in a different sequence without departing from the scope of the claims herein. Various embodiments and variants disclosed with the aforementioned renewable energy metering and metering and monitoring device (such as the renewable energy metering and monitoring device 104A) apply mutatis mutandis to the aforementioned method 600.

In one aspect, the present disclosure provides a computer program product comprising program instructions for performing the method 600, when executed by one or more processors (e.g., the controller 310 of the renewable energy metering and monitoring device 104A). In a yet another aspect, the present disclosure provides a non-transitory computer-readable storage medium comprising instructions which, when executed by a computer, cause the computer to carry out the method 600 of tamper-resilient capture and verification of renewable energy production.

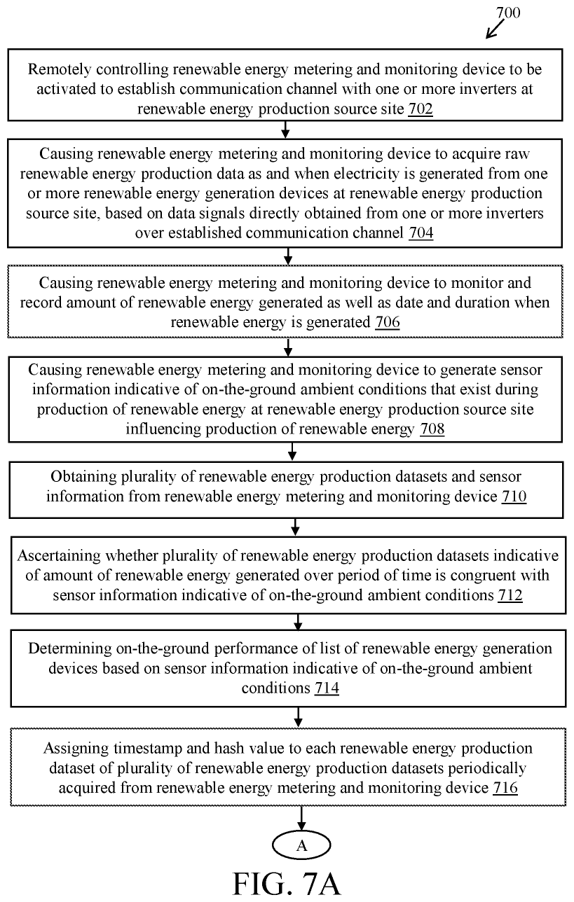

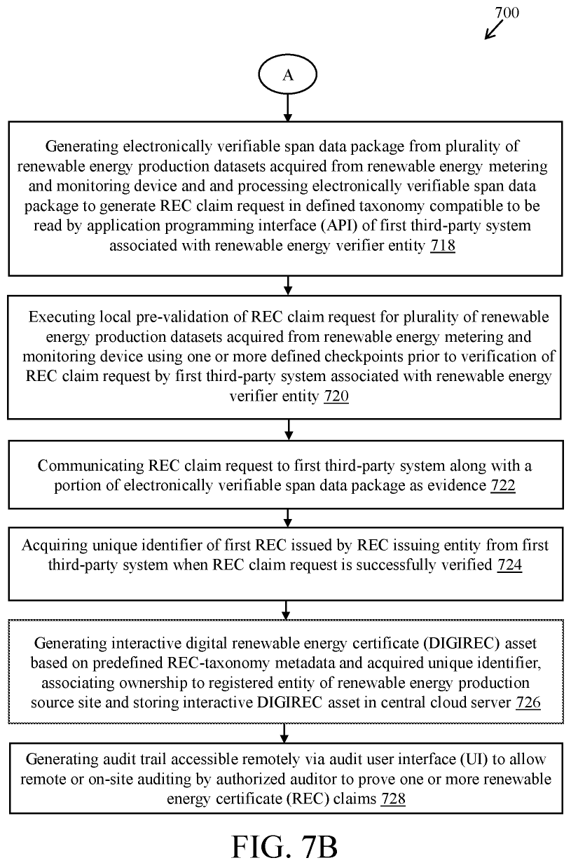

FIGS. 7A and 7B, collectively, is a diagram illustrating a flowchart of a method of tamper-resilient capture and verification of renewable energy production, in accordance with another embodiment of the present disclosure. FIGS. 7A and 7B are described in conjunction with elements from FIGS. 1, 2, 3A, 3B, 3C, 4, 5 and 6. With reference to the FIGS. 7A and 7B, there is shown a method 700 that includes steps 702 to 728. The central cloud server 102 of the system 100 (of FIG. 1) may be configured to execute the method 700.

Referring to FIG. 7A, at 702, a renewable energy metering and monitoring device (i.e., the renewable energy metering and monitoring device 104A) to be activated to establish a communication channel with one or more inverters (i.e., the one or more inverters 116) at a renewable energy production source site (i.e., the renewable energy production source site 118) may be remotely controlled.

At 704, the renewable energy metering and monitoring device 104A may be caused to acquire raw renewable energy production data as and when electricity is generated from one or more renewable energy generation devices at the renewable energy production source site 118, based on data signals directly obtained from the one or more inverters 116 over the established communication channel.

At 706, the renewable energy metering and monitoring device 104A may be caused to monitor and record an amount of renewable energy generated as well as a date and a duration when the renewable energy is generated.

At 708, the renewable energy metering and monitoring device 104A may be caused to generate sensor information indicative of on-the-ground ambient conditions (i.e., the on-the-ground ambient conditions 314) that exist during the production of renewable energy at the renewable energy production source site 118 influencing the production of renewable energy.

At 710, a plurality of renewable energy production datasets (i.e., the plurality of renewable energy production datasets 208) and the sensor information may be obtained from the renewable energy metering and monitoring device 104A.

At 712, it may be ascertained whether the plurality of renewable energy production datasets indicative of an amount of renewable energy generated over a period of time is congruent with the sensor information indicative of the on-the-ground ambient conditions 314.

At 714, an on-the-ground performance of a list of renewable energy generation devices (i.e., the list of renewable energy generation devices 114) may be determined based on the sensor information indicative of the on-the-ground ambient conditions 314.

At 716, a timestamp and a hash value may be assigned to each renewable energy production dataset of the plurality of renewable energy production datasets 208 periodically acquired from the renewable energy metering and monitoring device 104A.

Now referring to FIG. 7B, at 718, an electronically verifiable span data package (e.g., the electronically verifiable span data package 212) is generated using the plurality of renewable energy production datasets 208 acquired from the renewable energy metering and monitoring device 104A and the electronically verifiable span data package 212 is processed to generate a REC claim request in a defined taxonomy compatible to be read by an application programming interface (e.g., the API 122) of a first third-party system (e.g., the first third-party system 120) associated with the renewable energy verifier entity 106.

At 720, a local pre-validation of the REC claim request for the plurality of renewable energy production datasets 208 acquired from the renewable energy metering and monitoring device 104A may be executed using one or more defined checkpoints prior to verification of the REC claim request by the first third-party system (i.e., the first third-party system 120) associated with the renewable energy verifier entity 106.

At 722, the REC claim request may be communicated to the first third-party system 120 along with a portion of the electronically verifiable span data package 212 as evidence.

At 724, a unique identifier of a first REC issued by a REC issuing entity (i.e., the REC issuing entity 108) may be acquired from the first third-party system (i.e., the first third-party system 120) when the REC claim request is successfully verified.

At 726, an interactive digital renewable energy certificate (DIGIREC) asset (i.e., the interactive DIGIREC asset 218) may be generated based on at least the acquired unique identifier, may be associated ownership to a registered entity (i.e., the registered entity 126) of the renewable energy production source site 118 and may be stored the interactive DIGIREC asset 218 in the central cloud server 102.

At 728, an audit trail (i.e., the audit trail 222) may be generated, which is accessible remotely via an audit user interface (UI) to allow remote or on-site auditing by an authorized auditor to prove one or more renewable energy certificate (REC) claims, and where the audit trail 222 is generated based on the plurality of renewable energy production datasets 208 acquired periodically from the renewable energy metering and monitoring device 104A located at the renewable energy production source site 118.

The steps 702 to 728 are only illustrative and other alternatives can also be provided where one or more steps are added, one or more steps are removed, or one or more steps are provided in a different sequence without departing from the scope of the claims herein. Various embodiments and variants disclosed with the aforementioned system (such as the system 100) apply mutatis mutandis to the aforementioned method 700.

In one aspect, the present disclosure provides a computer program product comprising program instructions for performing the method 700, when executed by one or more processors (e.g., the central cloud server 102 of the system 100). In a yet another aspect, the present disclosure provides a non-transitory computer-readable storage medium comprising instructions which, when executed by a computer, cause the computer to carry out the method 700 of tamper-resilient capture and verification of renewable energy production.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A renewable energy metering and monitoring device, comprising:
a network interface configured to establish a communication channel with one or more inverters at a renewable energy production source site;
a data acquisition circuit configured to acquire raw renewable energy production data as electricity is generated from one or more renewable energy generation devices at the renewable energy production source site based on data signals directly obtained from the one or more inverters over the established communication channel;
a meter configured to monitor and record an amount of renewable energy generated as well as a date and a duration when the renewable energy is generated;
a sensor circuit board connected to the data acquisition circuit and the meter, wherein the sensor circuit board is communicatively coupled to one or more sensors configured to generate sensor information indicative of on-the-ground ambient conditions that exist during renewable energy production at the renewable energy production source site influencing production of renewable energy; and
a controller configured to communicate a plurality of renewable energy production datasets to a central cloud server,
wherein the central cloud server is configured to generate an electronically verifiable span data package from the plurality of renewable energy production datasets that is processed to generate a renewable energy certificate (REC) claim request in a defined taxonomy compatible to be read by an application programming interface (API) of a first third-party system associated with a renewable energy verifier entity.

2. The renewable energy metering and monitoring device according to claim 1, wherein the on-the-ground ambient conditions comprises one or more of: a weather condition, an air quality or pollution condition, a wind speed parameter, an air temperature parameter, an atmospheric pressure condition, a terrain condition, a relative humidity (RH) condition, a rainfall condition, a precipitable water condition, a Snow Days (SD) condition, a CoolingDegree Days (CDDs) condition, and a HeatingDegree Days (HDDs) condition.

3. The renewable energy metering and monitoring device according to claim 2, wherein the on-the-ground ambient conditions further comprise a first detection value indicative of whether a device-to-device connection between the renewable energy metering and monitoring device and the one or more inverters is maintained or lost, and if lost then record a duration of loss of the device-to-device connection.

4. The renewable energy metering and monitoring device according to claim 3, wherein the on-the-ground ambient conditions further comprise a second detection value indicative of whether a physical protection for secured access to the renewable energy metering and monitoring device is breached, and a logged access time.

5. The renewable energy metering and monitoring device according to claim 1, wherein the controller of the renewable energy metering and monitoring device is further configured to ascertain whether the raw renewable energy production data is aligned with the sensor information indicative of the on-the-ground ambient conditions.

6. The renewable energy metering and monitoring device according to claim 1, wherein the network interface of the renewable energy metering and monitoring device is connected to a corresponding data port of the one or more inverters to securely obtain data signals from the one or more inverters over the established communication channel.

7. The renewable energy metering and monitoring device according to claim 1, wherein the controller of the renewable energy metering and monitoring device is further configured to communicate supplementary information to the central cloud server,
wherein the supplementary information comprises a location of the renewable energy production source site, a fuel type indicative of a type of renewable energy used, device information of a list of renewable energy generation devices and the one or more inverters located at the renewable energy production source site, wherein the central cloud server is further configured to utilize the supplementary information for the generation of the electronically verifiable span data package.

8. The renewable energy metering and monitoring device according to claim 1, wherein the controller is further configured to execute a local pre-validation of the plurality of renewable energy production datasets using one or more defined checkpoints prior to communication to the central cloud server.

9. The renewable energy metering and monitoring device according to claim 1, wherein the controller of the renewable energy metering and monitoring device is further configured to determine an on-the ground performance of a list of renewable energy generation devices based on the sensor information.

10. The renewable energy metering and monitoring device according to claim 1, wherein a renewable energy certificate (REC) claim request is generated and communicated by the central cloud server to the first third-party system along with a portion of the electronically verifiable span data package as evidence, which is further used to issue a first REC by a REC issuing entity when the REC claim request is successfully verified.

11. The renewable energy metering and monitoring device according to claim 10, wherein a unique identifier associated with the first REC is acquired and converted to an interactive digital renewable energy certificate (DIGIREC) asset based on a predefined REC-taxonomy metadata stored at the central cloud server, and wherein the interactive DIGIREC asset is a digital exchangeable energy attribute certificate based asset that provides an assurance of an authenticity about production of a unit of electricity through renewable energy through an objective digital evidence chain of custody based on a multi-layered verification of renewable energy production corresponding to the plurality of renewable energy production datasets.

12. A system of tamper-resilient capture and verification of renewable energy production, the system comprising:
a renewable energy metering and monitoring device disposed at a renewable energy production source site; and
a central cloud server communicatively coupled to the renewable energy metering and monitoring device,
wherein the renewable energy metering and monitoring device is configured to:
establish a communication channel with one or more inverters at the renewable energy production source site;
acquire raw renewable energy production data as electricity is generated from one or more renewable energy generation devices at the renewable energy production source site, based on data signals directly obtained from the one or more inverters over the established communication channel;
monitor and record an amount of renewable energy generated as well as a date and a duration when the renewable energy is generated;
generate sensor information indicative of on-the-ground ambient conditions that exist during production of renewable energy at the renewable energy production source site influencing the production of renewable energy; and
communicate a plurality of renewable energy production datasets and the sensor information to a central cloud server,
and wherein the central cloud server is configured to:
generate an electronically verifiable span data package from the plurality of renewable energy production datasets and process the electronically verifiable span data package to generate renewable energy certificate (REC) claim request in a defined taxonomy compatible to be read by an application programming interface (API) of a first third-party system associated with a renewable energy verifier entity; and
communicate the REC claim request to the first third-party system along with a portion of the electronically verifiable span data package as evidence.

13. The system according to claim 12, wherein the central cloud server is further configured to ascertain whether the plurality of renewable energy production datasets indicative of an amount of renewable energy generated over a period of time is congruent with the sensor information indicative of the on-the-ground ambient conditions.

14. The system according to claim 12, wherein the central cloud server is further configured to determine an on-the-ground performance of a list of renewable energy generation devices based on the sensor information indicative of the on-the-ground ambient conditions.

15. The system according to claim 12, wherein the central cloud server is further configured to assign a timestamp and a hash value to each renewable energy production dataset of the plurality of renewable energy production datasets periodically acquired from the renewable energy metering and monitoring device.

16. The system according to claim 12, wherein the central cloud server is further configured to:
acquire, from the first third-party system, a unique identifier of a first REC issued by a REC issuing entity when the REC claim request is successfully verified; and
generate an interactive digital renewable energy certificate (DIGIREC) asset based on at least the acquired unique identifier, associate ownership to a registered entity of the renewable energy production source site and store the interactive DIGIREC asset in the central cloud server.

17. The system according to claim 12, wherein the central cloud server is further configured to execute a local pre-validation of the REC claim request for the plurality of renewable energy production datasets acquired from the renewable energy metering and monitoring device using one or more defined checkpoints prior to verification of the REC claim request by the first third-party system associated with the renewable energy verifier entity.

18. The system according to claim 12, wherein the electronically verifiable span data package comprises:
a first type of data item comprising REC claim information details, a claim date of the REC claim request, a checkpoint source, a data structure related to the defined taxonomy, a fuel type indicative of a type of renewable energy used, a production capacity of renewable energy production source site, an identifier of the renewable energy production source site, and account information associated with the renewable energy production source site assigned by the renewable energy verifier entity; and
a second type of data item comprising a plurality of device identities (IDs) and corresponding energy production data associated with each device ID over a specified period as source evidence.

19. The system according to claim 12, wherein the central cloud server in coordination with the renewable energy metering and monitoring device is further configured to generate an audit trail accessible remotely via an audit user interface (UI) to allow remote or on-site auditing by an authorized auditor to prove one or more renewable energy certificate (REC) claims, and wherein the audit trail is generated based on the plurality of renewable energy production datasets acquired periodically from the renewable energy metering and monitoring device located at the renewable energy production source site.

20. A method of tamper-resilient capture and verification of renewable energy production, the method comprising:
establishing, by a renewable energy metering and monitoring device, a communication channel with one or more inverters at a renewable energy production source site;
acquiring, by the renewable energy metering and monitoring device, raw renewable energy production data as electricity is generated from one or more renewable energy generation devices at the renewable energy production source site, based on data signals directly obtained from the one or more inverters over the established communication channel;
monitoring and recording, by the renewable energy metering and monitoring device, an amount of renewable energy generated as well as a date and a duration when the renewable energy is generated;
generating, by the renewable energy metering and monitoring device, sensor information indicative of on-the-ground ambient conditions that exist during production of renewable energy at the renewable energy production source site influencing the production of renewable energy;
communicating by the renewable energy metering and monitoring device, a plurality of renewable energy production datasets, and the sensor information to a central cloud server; and
generating, by the central cloud server, an electronically verifiable span data package from the plurality of renewable energy production datasets and processing the electronically verifiable span data package to generate a REC claim request in a defined taxonomy compatible to be read by an application programming interface (API) of a first third-party system associated with a renewable energy verifier entity.
